(19) United States
(12) Patent Application Publication
(10) Pub. No.: US 2017/0237119 A1
(43) Pub. Date: Aug. 17, 2017

(54) LI-ION ELECTROLYTE MEMBRANE FACILITATED BY A SELF-HEALING POLYMER MATRIX, AND ASSOCIATED BATTERY

(71) Applicant: The Regents of the University of Colorado, a body corporate, Denver, CO (US)

(72) Inventors: Wei Zhang, Superior, CO (US); Philip Taynton, Morrison, CO (US)

(21) Appl. No.: 15/276,777

(22) Filed: Sep. 26, 2016

Related U.S. Application Data
(63) Continuation-in-part of application No. 14/656,684, filed on Mar. 12, 2015, now Pat. No. 9,453,099.
(60) Provisional application No. 61/951,613, filed on Mar. 12, 2014.

(51) Int. Cl. H01M 10/0565; H01M 10/0562; H01M 10/0525; C08J 5/22; C08G 12/06

(52) U.S. Cl. CPC H01M 10/0565; C08J 5/2275; C08G 12/06; H01M 10/0525; H01M 10/0562; C08J 2361/22; H01M 2300/0085; H01M 2300/0025; H01M 2300/002; H01M 2220/20

(57) ABSTRACT

Disclosed herein are compositions and methods of making novel covalently cross-linked polyimines that are non-malleable under standard conditions but yet may be rendered malleable. Also disclosed is an electrode having an electrolyte component mixed with a self-healing polyimine

### RELATED APPLICATIONS

This application is a continuation-in-part of U.S. Ser. No. 14,656,684, filed 12 Mar. 2015, which claims priority of U.S. Provisional Patent Application No. 61/951/613, filed 12 Mar. 2014, both of which are incorporated herein in their entirety.

### STATEMENT REGARDING FEDERALLY SPONSORED RESEARCH

This invention was made with government support under grant number DMR105570 awarded by the National Science Foundation. The government has certain rights in the disclosure.

This work was funded by the Membrane Science, Engineering and Technology (MAST) Center at CU-Boulder, an NSF Industry-University Cooperative Research Center.

### FIELD OF THE INVENTION

The present invention generally relates to malleable polymers and their systems and methods of use.

### BACKGROUND

Polymers with covalently cross-linked networks are commonly referred to as thermosets. Thermosets get this name from the fact that they cannot flow upon heating and thus cannot be reshaped and recycled. Conventional network polymers, such as thermosets, obtain their shape as they are synthesized. After taking shape, they cannot be reprocessed and recycled, see Aklonis & MacKnight, Introduction to Polymer Viscoelasticity, 2nd ed., New York: Wiley, 1983.

In contrast to thermosets, network polymers with dynamic covalent bonds (DCB) allow for bond exchange reactions (BER) that can alter network topology. In DCB polymers, the covalently connected backbone of the macromolecular chain can cleave then reconnect through bond exchange reactions (BER). Such dynamic covalent bond reformation activities do not change the network topology and properties, but enable macroscopic stress relaxation and material welding.

DCB polymers that have been synthesized either require the inclusion of expensive catalysts (see, for example, WO2014086974A1 to Leibler et al.) and/or have BER that are highly active under ambient conditions, and thus cannot replace most thermoset materials.

A composite material (also called a “composition material”, or simply a “composite”) is a material made of two or more constituent materials. The constituent materials (“constituents”) may have significantly different physical or chemical properties. The individual constituents remain separate and distinct within the finished composite, lending the composite unique characteristics not necessarily found in any of its constituents, which may make the composite preferable over other material choices. For example, the composite may be stronger, lighter, or less expensive than traditional fabrication materials.

There are two main categories of constituent materials: matrix and reinforcement. A composite material requires inclusion of at least a portion of each type of constituent material. Matrix material surrounds and supports the reinforcement material(s) by maintaining relative positions of the reinforcement material(s) embedded therein. The reinforcements impart their unique mechanical and physical properties to enhance properties of the matrix, for example strengthening the overall composite. Due to the wide variety of reinforcement and matrix materials and synergy therebetween, composites are highly customizable materials which may be composed and selected for task-, property-, design-, and use-specific applications.

Composites include but are not limited to: Fiber-reinforced polymers (“FRPs”), such as carbon-fiber-reinforced polymer (“CFRP”) and glass-reinforced plastic (“GRP”); metal matrix composites (“MMC”), which use metal fibers to reinforce other metals; ceramic matrix composites (“CMC”) such as cermet (ceramic and metal), concrete, and ceramic fiber reinforced ceramic (“CFRC”) in which ceramic fibers are embedded in a ceramic matrix. Even bone, which includes living cells in a ceramic/water/organic material matrix, may be considered a CMC.

Like conventional network polymers, engineered composite materials must be formed to shape. The matrix material may be introduced to the reinforcement before or after the reinforcement material is placed into a mold cavity or onto a mold surface. Following a melding event (for example, chemical polymerization or solidification from a melted state), the part shape is essentially set. Many commercially produced composites use a polymer matrix material, or resin solution. Polymer matrix materials include materials in the polyesters, vinyl esters, epoxies, phenolics, polyimides, polyamides, polypropylenes, polyimines, PEEK (polyetheretherketone) and others. Reinforcement materials are often fibers, ground organic materials and ground inorganic materials.

A filler or fillers are particles added to a material such as plastic, composite material or concrete to lower the amount of more expensive binder or matrix material required or to enhance some property of the mixed material. Fillers are generally grouped into conductive fillers and extender fillers. Composite fillers and reinforcements may be used to change and improve the functional, physical, mechanical and thermal properties of a plastic or other material. For example, fillers may be chosen to modify thermal conductivity, moisture absorption, electrical resistivity, electrical conductivity, friction, wear resistance and flame resistance. Reinforcements may be chosen to modify specific properties of the compounds to which they are added. Specialized particulates, fibers or fabrics may serve as reinforcements to strengthen or toughen plastic, metals or ceramics. Reinforcement generally adds rigidity to and impedes crack propagation within a finished product. Thin reinforcement fibers may be very strong, and provided that they are mechanically well attached with the matrix, they may greatly improve a composite's overall properties.

Fillers and reinforcements may differ in features and specifications. Carbon fiber reinforcement is a non-woven, carbon fiber, epoxy-based grid that is used to reduce cracking and extend life in concrete. Carbon fiber reinforcements are relatively lightweight and corrosion resistant. Different polymer reinforcement techniques are used to enhance the properties of polymers. Fiber reinforcement for concrete structures should have properties such as low shrinkage, good thermal expansion, substantial modulus of elasticity, high tensile strength, improved fatigue, and impact resistance. Plastic filler can be specified according to brightness, density, abrasion, fineness, and oil absorption. Fillers and reinforcements that are characterized by a low aspect ratio between the longest and the shortest dimensions are less changeable than unfilled polymers. When the aspect ratio between the longest and the shortest dimension of the filler is greater than 25, the filler can be characterized as a fiber.

Fillers and reinforcements are used in many applications and industries. Examples include aerospace, appliances, automotive, construction, electronic, consumer products, corrosion, and marine. Specialized fillers and reinforcements can also be used in medical applications. Fillers and reinforcements adhere to standards specified by the Society of Plastics Engineers (SPE), and the American Society of Civil Engineers ASCE. The most commonly used fillers and extenders (extender fillers) in industries are aluminum powder, carbon fiber, graphite, calcium carbonate, silica and clay.

Fiber-reinforced composite materials can be divided into two main categories, normally referred to as short fiber-reinforced materials and continuous fiber-reinforced materials. Adding short fibers to a composite material may for example improve the composite performance for lightweight applications, while increasing ease of manufacture and cost savings, as opposed to continuous reinforced materials. Continuous reinforced materials will often constitute a layered or laminated structure. The woven and continuous fiber styles are typically available in a variety of forms, being pre-impregnated with the given matrix (resin), dry, uni-directional tapes of various widths, plain weave, harness satins, braided, and stitched.

Short and long/continuous fibers are typically incorporated into fiber-reinforced composite materials in compression moulding and sheet moulding operations. The fibers may be obtained in the form of flakes, chips, and random mate (which can also be made from a continuous fiber laid in random fashion until the desired thickness of the ply/laminate is achieved). Common reinforcement fibers include, but are not limited to glass fibers, carbon fibers, cellulose (wood/paper fiber and straw) and high strength polymers such as aramid. Silicon carbide fibers are used for some high temperature applications.

The physical properties of composite materials typically anisotropic (different depending on the direction of the applied force or load) and not isotropic (independent of direction of applied force). For instance, the stiffness of a composite panel will often depend upon the orientation of applied forces and/or moments. Panel stiffness is also dependent on the design of the panel. For instance, the fiber reinforcement and matrix used, the method of panel build, whether the composite is thermoset or thermoplastic, the type of weave, and the orientation of fiber axis to the primary applied force all affect stiffness of the panel.

In contrast, stiffness of isotropic materials (for example, aluminium or steel) in standard wrought forms typically remains constant regardless of the direction of applied forces and/or moments.

The relationship between force/moment and strain/curvature for an isotropic material can be described with the following material properties: Young's Modulus, the shear Modulus and the Poisson's ratio, in relatively simple mathematical relationships. Describing force/moment and strain/curvature relationships of an anisotropic material requires the mathematics of a second order tensor and up to 21 material property constants. For the special case of orthogonal isotropy, there are three different material property constants for each of Young's Modulus, Shear Modulus and Poisson's ratio—total of 9 constants to describe the relationship between force/moment and strain/curvature.

### SUMMARY

Disclosed herein are novel polyimine DCB polymers compositions which do not require a catalyst, and exhibit thermoset-like behavior at room temperature. Polyimine DCB polymers disclosed herein exhibit reprocessability and recyclability at elevated temperature without inclusion of catalysts, and further exhibit a very unique moisture-trigger for stress relaxation which can be modulated by monomer choice. The polyimine DCB polymers disclosed herein are robust, yet remoldable.

Also disclosed herein are methods for making and using polyimine DCB polymers as well as composite materials that incorporate polyimine DCB polymers. These polymers and composite materials are moldable and reshapeable like thermoplastic sheet stock. Further disclosed are methods for using the novel polyimine DCB polymers disclosed herein.

In an aspect, a polyimine polymer is disclosed capable of repeating at least one cycle of transitioning between a non-malleable state and a malleable state and between a malleable state and a non-malleable state upon exposure to a temperature range having a low temperature range that is below a transitional temperature wherein said polymer exhibits rates of bond exchange reactions that impart a non-malleable state to said polymer and a high temperature range above said transitional temperature wherein said polymer exhibits rates of bond exchange reactions that impart a malleable state to said polymer. In an embodiment, the polyimine polymer is a vitrimer. In another embodiment, the polyimine polymer exhibits a bond exchange reaction that is selected from an imine formation reaction, an imine exchange reaction, and an imine hydrolysis reaction. In another embodiment, the polyimine polymer has a transitional temperature is from about 10° C. to about 250° C. In yet another embodiment, the polyimine polymer has a transition temperature is from about 30° C. to about 250° C. In an embodiment, the polyimine polymer has a transitional temperature is from about 30° C. to about 100° C. In another embodiment, the polyimine polymer has a transitional temperature at about 56° C. In an embodiment, the polyimine polymer exhibits a Young's modulus of between about 1.0 and about 1.8 GPa. In another embodiment, the polyimine polymer exhibits a Tensile Strength modulus of between about 40 and about 58 MPa. In another embodiment, the polyimine polymer exhibits a Processing Temperature of about 80° C. In an embodiment, the polyimine polymer exhibits a Young's modulus of between about 1.0 and about 1.8 GPa and a Tensile Strength modulus of between about 40 and about 58 MPa and a Processing Temperature of about 80° C. In yet another embodiment, the polyimine polymer has a stress relaxation that exhibits Arrhenius-like temperature dependence. In an embodiment, the polyimine polymer does not contain a catalyst. In yet another embodiment, the polyimine polymer is elastomeric, and capable of strains in excess of 150% elongation. In an embodiment, the polyimine polymer is hydrophobic, and exhibits less than 10% weight increase when immersed in an aqueous solution for 24 hours (h). In an embodiment, the polyimine polymer is immersed in an aqueous solution that is water. In another embodiment, the polyimine polymer has dicarbonyl monomers, diamine monomers, and cross-linking agents. In another embodiment, the polyimine polymer is prepared by condensation of at least one dicarbonyl monomer, at least one diamine monomer, and at least one cross-linking agent. In an embodiment, the polyimine polymer has at least one cross-linking agent that is a multivalent carbonyl monomer or a multivalent amine monomer. In an embodiment, the polyimine polymer has at least one dicarbonyl monomer that has at least one aromatic aldehyde group. In another embodiment, the polyimine polymer has a dicarbonyl monomer that includes glyoxal, malonaldehyde, glutaraldehyde, 2,3-thiophenedicarbaldehyde, 2,5-thiophenedicarbaldehyde, 3-formylfurfural, 5-formylfurfural, 2,6-pyridinedicarboxaldehyde, 3,6-pyridinedicarboxaldehyde, 3,5-pyridinedicarboxaldehyde, isophthaldehyde, terephthaldehyde, phthaldialdehyde, phenylglyoxal, pyrroledicarboxaldehyde, 2,3-butanedione, 2,4-pentanedione, 4-cyclopentene-1,3-dione, 1,3-cyclopentanedione, 1,2-benzoquinone, 1,4-benzoquinone, cyclohexanedione, 3,4-dihydroxy-3-cyclobutene-1,2-dione, 1,3-indandione, ninhydrin, 1,4-naphthoquinone, 1,2-naphthoquinone, diacetylbenzene, acenaphthenequinone, and anthraquinone. In an embodiment, the polyimine polymer has at least one diamine monomer that has at least one aliphatic amine group. In another embodiment, the polyimine polymer has at least one diamine monomer that includes a hydrazine, ethylenediamine, propylenediamine, 1,4-diaminobutane, 1,5-diaminopentane, 1,6-diaminohexane, 1,7-diaminoheptane, 1,8-diaminooctane, 1,9-diaminononane, 1,10-diaminodecane, phenylenediamine, phenylenedimethylenamine, diaminocyclohexane, diaminocyclopentane, diaminocyclobutane, diaminothiophene, diaminopyridine, diaminopyrrole, diaminofuran, diaminoimidazole, diaminooxazole, 3,6,9-trioxaundecan-1,11-diamine, and diethylenetriamine. In another embodiment, the polyimine polymer has at least one multivalent amine monomer including triethylenetetramine, 3-ethylamino-1,5-diaminopentane, triaminobenzene, and triaminocyclohexane. In an embodiment, the polyimine polymer includes multivalent carbonyl monomer comprises benzene-1,3,5-tricarboxaldehyde, 2,4,6-trihydroxy-1,3,5-benzenetricarboxaldehyde, hexaketocyclohexane, and 2-acetyl-1,3-cyclohexanedione. In an embodiment, the polyimine polymer includes at least one dicarbonyl monomer, at least one diamine monomer, and at least one cross-linking agent are reacted in amounts such that the molar equivalent ratios for (i) carbonyl groups from the dicarbonyl monomer, (ii) amine groups from the diamine monomer, and (iii) amine groups or carbonyl groups from the cross-linking agent range from about 1:0.99:0.01 to about 1:0.01:0.99. In yet another embodiment, the polyimine polymer has at least one dicarbonyl monomer, at least one diamine monomer, and at least one cross-linking agent that are reacted in amounts such that the molar equivalent ratios for total amino groups to total carbonyl groups is about 1:1. In another embodiment, the polyimine polymer includes a difunctional monomer including a carbonyl group, and a protected primary amine wherein a difunctional monomer polymerizes upon deprotection of a protected primary amine In an embodiment, the polyimine polymer includes a cross-linking agent. In another embodiment, the polyimine polymer includes a cross-linking agent that has a multivalent carbonyl monomer or a multivalent amine monomer. In an embodiment, the polyimine polymer includes a difunctional monomer including a protected carbonyl group, and a primary amine wherein the difunctional monomer polymerizes upon deprotection of the protected carbonyl group. In an embodiment, the polyimine polymer includes a cross-linking agent. In yet another embodiment, the polyimine polymer has a cross-linking agent that includes a multivalent carbonyl monomer or a multivalent amine monomer.

In another aspect, a polyimine polymer capable of repeating at least one cycle of transitioning between a non-malleable state and a malleable state and between a malleable state and a non-malleable state upon exposure to a range of relative humidity has a low humidity range that is below a transitional relative humidity point wherein said polymer exhibits rates of bond exchange reactions that impart a non-malleable state to the polymer; and a high humidity range above said transitional relative humidity point wherein said polymer exhibits rates of bond exchange reactions that impart a malleable state to the polymer. In an embodiment, the polyimine polymer is a vitrimer. In another embodiment, the polyimine polymer has a bond exchange reaction is selected from an imine formation reaction, an imine exchange reaction, and an imine hydrolysis reaction. In another embodiment, the polyimine polymer has a transitional relative humidity point that is from about 50 to about 90 percent relative humidity. In yet another embodiment, the polyimine polymer has a transitional relative humidity point is from about 70 to about 90 percent relative humidity. In an embodiment, the polyimine polymer has a high humidity range that is caused by immersion in an aqueous solution. In an embodiment, the polyimine polymer has a high humidity range that is caused by immersion in an aqueous solution that is water. In an embodiment, the polyimine polymer has a non-malleable state of the polymer that exhibits a Young's modulus of between about 1.0 and about 1.8 GPa. In an embodiment, the polyimine polymer has a non-malleable state of the polymer that exhibits a Tensile Strength modulus of between about 40 and about 58 MPa. In another embodiment, the polyimine polymer exhibits a Young's modulus of between about 1.0 and about 1.8 GPa and a Tensile Strength modulus of between about 40 and about 58 MPa and a Processing Temperature of about 80° C. In an embodiment, the polyimine polymer has a stress relaxation of the non-malleable state of the polyimine polymer that exhibits Arrhenius-like temperature dependence. In an embodiment, the polyimine polymer does not contain a catalyst. In an embodiment, the polyimine polymer of contains dicarbonyl monomers, diamine monomers, and cross-linking agents. In an embodiment, the polyimine polymer is prepared by condensation of at least one dicarbonyl monomer, at least one diamine monomer, and at least one cross-linking agent. In an embodiment, the polyimine polymer contains at least one dicarbonyl monomer, and at least one diamine monomer, and the at least one cross-linking agent are reacted in amounts such that the molar equivalent ratios for (i) carbonyl groups from the dicarbonyl monomer, (ii) amine groups from the diamine monomer, and (iii) amine groups or carbonyl groups from the cross-linking agent range from about 1:0.99:0.01 to about 1:0.01:0.99. In another embodiment, the polyimine polymer contains at least one dicarbonyl monomer, and the at least one diamine monomer, and the at least one cross-linking agent are reacted in amounts such that the molar equivalent ratios for total amino groups to total carbonyl groups is about 1:1.

In an aspect, a polyimine polymer capable of repeating at least one cycle of transitioning between a non-malleable state and a malleable state and between a malleable state and a non-malleable state upon exposure to a temperature range includes a low temperature range that is below a transitional temperature wherein the polymer exhibits rates of bond exchange reactions that impart a non-malleable state to the polymer, and includes a high temperature range above the transition temperature wherein said polymer exhibits rates of bond exchange reactions that impart a malleable state to the polymer, and wherein the polyimine polymer comprises a metal additive, and wherein the metal additive results in an increase in the transition temperature relative to the polyimine polymer without the metal additive. In an embodiment, the polyimine polymer is a vitrimer. In another embodiment, the bond exchange reaction is selected from an imine formation reaction, an imine exchange reaction, and an imine hydrolysis reaction. In an embodiment, the polyimine polymer includes a transition temperature that is from about 10° C. to about 250° C. In another embodiment, the polyimine polymer includes a transition temperature that is from about 30° C. to about 250° C. In yet another embodiment, the polyimine polymer includes a transition temperature that is from about 30° C. to about 100° C. In an embodiment, the polyimine polymer has a transitional temperature that is about 80° C. In another embodiment, the polyimine polymer includes a metal additive that is selected from the group of Scandium and Copper.

In an aspect, a composite material including a polyimine polymer binder and a filler capable of repeating at least one cycle of transitioning between a non-malleable state and a malleable state and between a malleable state and a non-malleable state upon exposure to a temperature range includes a low temperature range that is below a transitional temperature wherein the polymer exhibits rates of bond exchange reactions that impart a non-malleable state to the polymer, and a high temperature range above the transition temperature wherein the polymer exhibits rates of bond exchange reactions that impart a malleable state to the polymer. In an embodiment, the composite material includes a ratio of the binder to the filler is from about 9:1 to about 1:9. In yet another embodiment, the composite material includes carbon fiber, fiberglass, kevlar, ultra-high molecular weight polyethylene, and carbon nanotubes. In another embodiment, a method of processing the composite material includes, a.) contacting the composite material with a liquid including at least a molecule that has a primary amine moiety; and b.) allowing the composite material to substantially dissolve in the liquid of step a.); and c.) seperating a polymer solution from a fibrous or non-fibrous filler material. In another embodiment, a method of recycling the composite material includes: a.) contacting the composite material with a liquid including at least a molecule with a primary amine moiety; and b.) allowing the composite material to substantially dissolve in the liquid of step a.); and c.) seperating a polymer solution from a fibrous or non-fibrous filler material; and d.) using the polymer solution from step c.) to prepare polyimine polymers; and e.) using filler materials from step c.) to prepare composite materials.

In yet another aspect, a composite material including a polyimine polymer binder and a filler capable of repeating at least one cycle of transitioning between a non-malleable state and a malleable state and between a malleable state and a non-malleable state upon exposure to a range of relative humidity includes a low humidity range that is below a transitional relative humidity point wherein the polymer exhibits rates of bond exchange reactions that impart a non-malleable state to the polymer; and a high humidity range above the transitional relative humidity point wherein the polymer exhibits rates of bond exchange reactions that impart a malleable state to the polymer. In an embodiment, the composite material has a ratio of the binder to the filler that is from about 9:1 to about 1:9. In another embodiment, the composite material includes carbon fiber, fiberglass, kevlar, ultra-high molecular weight polyethylene, and carbon nanotubes. In yet another embodiment, a method of processing the composite material includes: a.) contacting the composite material with a liquid comprising at least a molecule that has a primary amine moiety; and b.) allowing the composite material to substantially dissolve in the liquid of step a.); and c.) seperating a polymer solution from a fibrous or non-fibrous filler material. In yet another embodiment, a method of recycling the composite material includes: a.) contacting the composite material with a liquid including at least a molecule with a primary amine moiety; and b.) allowing the composite material to substantially dissolve in the liquid of step a.); and c.) seperating a polymer solution from a fibrous or non-fibrous filler material; and d.) using the polymer solution from step c.) to prepare polyimine polymers; and e.) using filler materials from step c.) to prepare composite materials.

In an aspect, a method for making the composite material includes: a.) combining at least one polyimine polymer layer in between at least two plies of composite; and b.) heating said combined layers and plies of step a.) to a temperature above said transitional temperature; and c.) pressing the heated combined layers and plies of step b.) into a mold; and d.) allowing the heated combined layers and plies of step c.) to cool to a temperature below the transitional temperature. In an embodiment, the composite material is an orthotic.

In an aspect, a method for making a composite material includes: a.) combining at least one polyimine polymer layer in between at least two plies of composite; and b.) wetting the combined layers and plies of step a.) to a high humidity range above said transitional relative humidity point; and c.) pressing the combined layers and plies of step b.) into a mold; and d.) allowing the combined layers and plies of step c.) to dry to a low humidity range below said transitional relative humidity point. In an embodiment, the composite material is an orthotic.

In another aspect, a polyimine polymer capable of repeating at least one cycle of transitioning between a non-malleable state and a malleable state and between a malleable state and a non-malleable state upon exposure to a temperature range includes a low temperature range that is below a transitional temperature wherein the polymer exhibits rates of bond exchange reactions that impart a non-malleable state to said polymer; and also includes a high temperature range above the transitional temperature wherein the polymer exhibits rates of bond exchange reactions that impart a malleable state to the polymer; and wherein the polyimine polymer is capable of self-healing in the low temperature range.

In an aspect, a polyimine polymer capable of repeating at least one cycle of transitioning between a non-malleable state and a malleable state and between a malleable state and a non-malleable state upon exposure to a range of relative humidity includes a low humidity range that is below a transitional relative humidity point wherein the polymer exhibits rates of bond exchange reactions that impart a non-malleable state to the polymer; and a high humidity range above the transitional relative humidity point wherein the polymer exhibits rates of bond exchange reactions that impart a malleable state to the polymer; and wherein the polyimine polymer is capable of self-healing in said low humidity range.

### BRIEF DESCRIPTION OF THE DRAWINGS

FIG. 1 depicts a general reaction scheme with dialdehyde, diamine and triamines being combined to make polyimine polymers.

FIG. 2 depicts various dialdehydes, diamines and cross-linkers used to make polyimine polymers.

FIG. 3 depicts stress relaxation curves of a polyimine polymer at various temperatures over a time period of 30 minutes.

FIG. 4 depicts temperature-time superposition master curve derived from data used for creating the curves as depicted in FIG. 3

FIG. 5 depicts shift factor versus temperature plot for a temperature-time superposition experiment. The line is derived from 80° C. reference temperature data from used for creating the curves as depicted in FIG. 3

FIG. 6 depicts the results of a Differential Scanning calorimetry (DSC) experiment to determine the T_{g} of a polyimine polymer.

FIG. 7 depicts the infrared spectrum of polyimine in which there is a prominent C═N stretch at 1,643 cm⁻¹ and the C═O stretch at 1,695 cm⁻¹ appears as a minor peak.

FIG. 8 depicts a stress versus strain mechanical test of an exemplary polyimine film sample.

FIG. 9 depicts ¹H NMR spectra of 35° C. sample over time and tracks the growth of the ab methylene peak from the ab compound depicted in Scheme 7.

FIG. 10 is a plot of the ratio of concentrations of [ab]/([aa]+[bb]) depicted in Scheme 7 as measured by the integration of the methylene peaks of each species as depicted in FIG. 16.

FIG. 11 depicts a schematic representation of polyimine composition cycling from a powder to being in an aluminum mold which is used to heat press the polyimine powder into solid disc by pressing the polyimine powder for 45 minutes at 80° C. under 90 kPa of pressure.

FIG. 12 depicts a stress-strain characterization four generations of subsequent polyimine discs formed from recycling the starting polyimine composition via the conditions as described in FIG. 11 as the polyimine disc is recycled through grinding into a powder and repeating the heat pressing to form a next generation of polyimine disc.

FIG. 13 depicts polyimine powder in aluminum mold and polymer discs formed by pressing wet powder under 90 kPa at room temperature for 24 hours, by heat pressing dry powder at 80° C. under 90 kPa for 40 minutes as well as forming a brittle polyimine compressed powder disc by pressing the polyimine powder under 90 kPa for 96 hours at room temperature.

FIG. 14 depicts a solid polyimine film which was dry, hard, and glassy, then soaked in tap water for 3 hours after which the wet film sample was stretched over round mold made from ping pong ball. Following 24 hours in a plastic zip bag with drying agent, a rounded shape film sample was equally hard and glassy as the beginning dry sample was obtained. As depicted in FIG. 14, the polymer's ability to retain its new shape was demonstrated by applying a pressure in excess of 190 g without substantial deformation of the solid.

FIG. 15 depicts a change in an exemplary polyimine polymer's mass over time when immersed in water, and when removed to a dry environment.

FIG. 16 depicts characteristic stress-strain behavior of an exemplary polyimine polymer at various levels of relative humidity (RH) including the stress strain curve of the polyimine polymer following 12 hours of immersion in water.

FIG. 17 depicts the relaxation modulus of a water-saturated polyimine sample. The measurement was performed under water. For a comparison, the results were plotted with the 127.5° C. stress-relaxation data from a TTSP study. The presence of water enabled more efficient relaxation than the most extreme heat condition studied.

FIG. 18 depicts exemplary magic angle spinning solid state ¹³C NMR of dry polyimine powder and wet polyimine powder, demonstrating structurally insignificant hydrolysis of the wet polyimine powder compared to the dry polyimine powder.

FIG. 19 depicts a series of hydrophobic and hydrophilic diamine monomer components used to make a series of respective polyimine polymers. FIG. 19 also depicts the percent swelling after soaking in water for 24 hrs and a tensile test of the respective polymers.

FIG. 20 depicts the relaxation modulus characteristics of a polyimine polymer that incorporates a hydrophobic diamine monomeric under dry conditions and after being soaked in water for 20 hours.

FIG. 21 depicts stress measurements of a series of polyimine polymers containing increasing levels of Scandium triflate.

FIG. 22 depicts stress measurements of a series of polyimine polymers containing increasing levels of Copper chloride.

FIG. 23 depicts an image of a flat stock sheet of a carbon fiber composite impregnated with a “hydrophilic 2” polyimine resin.

FIG. 24 depicts an image of a twill-weave carbon fiber composite material containing a “hydrophilic 2” polyimine resin. The composite is about 50:50 by weight fiber to resin. The rounded shape was thermoformed from a flat sheet.

FIG. 25 depicts a representation of a method to make a 3D structure from a flat 1-ply sheet of composite material that contains a polyimine resin, by making slits and bonded overlaps into the flat 1-ply composite sheet and then thermomolding into the 3D structure.

FIG. 26 depicts a schematic representation of a recycling cycle of 1-ply polyimine composite via depolymerization of polyimine using an excess of diamine monomer (liquid).

FIGS. 27A-C schematically and pictorially represent a solid electrolyte-in-polymer matrix (SEPM) prior to and after application of a hot isostatic press.

FIG. 28 illustrates the synthesis of polyimine formulations tri-imine, hexa-imine and methyl-imine, as used in forming an ultra-thin solid-state Li-ion electrolyte membrane with a self-healing polymer matrix.

FIGS. 29A-I present tensile test results for the polyimines/polymers of FIG. 28, temperature-dependent stress relaxation, and bond exchange energy.

FIGS. 30A-C display densities, Arrhenius plots and conductance of solid-electrolyte-in-polymer (SEPM) matrices inclusive of the above polyimines/polymers.

FIGS. 31A-F are microscopic views confirming the hypothesized structure of self-healing polymer dispersed throughout a densified solid electrolyte.

FIG. 32A displays a symmetric rate study comparing discharge performance of the SEPM cell to a standard a77.5 construction.

FIG. 32B shows long-term cycling at a rate of C/5.

FIG. 32C illustrates enhancement in gravimetric and volumetric energy densities by moving to an SEPM configuration.

FIGS. 33A-C show voltage profiles associated with the rate study of FIG. 32A.

FIGS. 34A-34C show AC impedance results for the temperature range of 23° C.-100° C. for a77.5 and SEPMs formed with the polyimine formulations of FIG. 28.

FIGS. 35A and 35B present differential scanning calorimetry and thermogravimetric analysis results of the methyl-imine formulation.

FIG. 36 displays long-term DC resistance of un-heat-treated composites in contact with lithium metal electrodes at 60 ° C.

### DETAILED DESCRIPTION

Disclosed herein are novel polyimine DCB polymers compositions which do not require a catalyst, and exhibit thermoset-like behavior at room temperature.

The imine-linked polymer, also referred to herein as a polyimine polymer, is a robust system for the development of dynamic covalent networks. An imine (also known as a Schiff base) is a carbon-nitrogen double bond typically formed by a condensation reaction between a primary amine and either an aldehyde or ketone. Since imine condensation simply requires an amine and an aldehyde or ketone, there is a wide variety of suitable monomers that are commercially available. Also, though imine condensation and imine exchange have been shown to be catalyzed by both Bronsted and Lewis acid catalysts, the reactions take place at reasonable rates at elevated temperatures even in the absence of a catalyst. Thus polyimines disclosed herein can be used for creating simple, easily accessible, and inexpensive malleable polymer networks useful for the development of reprocessable, functional polymeric materials in a variety of industrially and environmentally important applications such as self-healing polymers, solid-state adhesives, custom moldable protective equipment, custom moldable orthotic devices, moisture responsive smart polymers, corrosion-resistant coatings, among other applications.

Improved fabrication processes and novel polymers described herein may lower the cost and energy intensity of FRP (fiber-reinforced polymer) composites, thus potentially opening a wide range of applications that promote clean energy and energy efficiency. In one example, light-weighting of motor vehicles is a key strategy to increase transportation energy efficiency and fuel economy while continuing to meet safety standards. A 10% reduction in vehicle weight can improve fuel economy by 6-8% and increase range of a battery-powered vehicle by up to 10%. Compared to conventional steel, glass FRP composite components and systems may reduce mass by 25-30%, and carbon composite systems may reduce mass by 60-70%.

Wind energy may also benefit from FRP composites incorporating the polymers and fabrication processes described herein. Rigid, high-strength, and lightweight yet fatigue-resistant carbon FRP composites can enable lighter, longer wind turbine blades, which increase the generation of wind power. Wind could be the largest consumer of carbon FRP composites by 2018.

Lightweight, high-strength materials are also needed to make compressed gas storage tanks, such as storage tanks for vehicles that run on hydrogen and natural gas. Although current carbon FRP composites meet target performance criteria for on-vehicle, high-pressure hydrogen storage tanks, material and production costs currently preclude widespread use of such composites in compressed gas storage tanks.

Composites can also impart corrosion resistance and other properties that improve performance of industrial equipment and components. FRP composites may enable more efficient heat exchangers (i.e., fans, blowers and other equipment capable of withstanding corrosive or high-temperature processes), pipes and tanks with extended service life, better electrical insulation for machinery, improved flywheels for storing electricity, and enhanced electrical transmission lines. Other industries may also benefit by substituting low-cost, high performance FRP composites for existing materials. Improved structural materials for buildings, roads and bridges could enhance construction. Strong, lightweight composites could also extend the capabilities of marine and aeronautic industries. The above industries and components are given as examples, and do not limit use or application of the polymers disclosed herein or composites incorporating such polymers.

Non-limiting examples of imine reactions utilized in making imine polymers disclosed herein include imine formation, imine exchange, imine hydrolysis and imine reduction as depicted in Scheme 1 as follows:

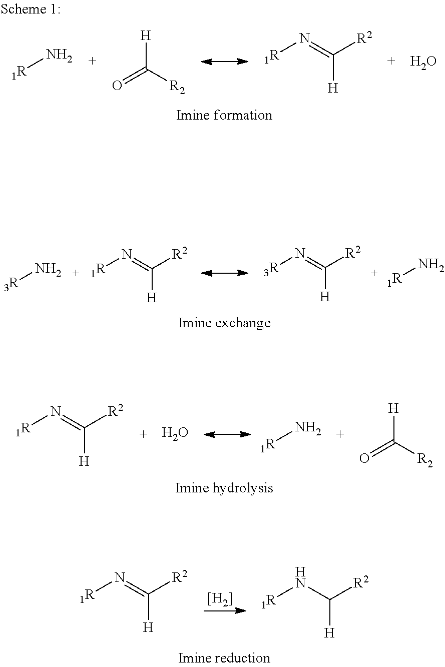

Without being limited by theory, stress relaxation mechanisms may be explained according to the following theory. At a single chain level, when BER occurs, the load in the original loaded chain will be transferred to a newly connected unloaded chain, thus the overall force is decreased.

The imine exchange reaction utilized herein is able to relax stress within the polymers at easily obtainable elevated temperatures without a catalyst. A catalyst free malleable material has the advantage of simplicity, lower toxicity and a lower price to manufacture. In an embodiment, tunability of the bond exchange kinetics and other properties of the polymers disclosed herein is achieved through monomer choice. Thus, considering the wide variety of commercially available monomers, and enormous range of properties is possible. In an embodiment, a catalyst and/or added metal can provide additional tunablity of the properties of the polymers.

DEFINITIONS

Unless defined otherwise, all technical and scientific terms used herein generally have the same meaning as commonly understood by one of ordinary skill in the art to which this disclosure belongs. Generally, the nomenclature used herein and the laboratory procedures in organic chemistry, and polymer chemistry are those well known and commonly employed in the art.

As used herein, the articles “a” and “an” refer to one or to more than one (i.e. to at least one) of the grammatical object of the article. By way of example, “an element” means one element or more than one element.

As used herein, the term “about” will be understood by persons of ordinary skill in the art and will vary to some extent on the context in which it is used. As used herein when referring to a measurable value such as an amount, a temporal duration, and the like, the term “about” is meant to encompass variations of ±20% or ±10%, more preferably ±5%, even more preferably ±1%, and still more preferably ±0.1% from the specified value, as such variations are appropriate to perform the disclosed methods.

As used herein, the term “rigid” as relating to a material refers to a material that cannot be (re)shaped, and/or (re)molded without suffering significant physical damage or injury. In an embodiment, the term “rigid” is synonymous with a material whose Young's modulus is higher than about 1.

As used herein, the term “dry form” as relating to a material refers to a material from which extraneous solvent (such as water) has been removed. In certain embodiments, a material in dry form is substantially free from all unbound solvent (such as absorbed or adsorbed solvent) therein. In other embodiments, a material in dry form still comprises solvent which is tightly bound to the material and can only be removed by physical or chemical methods that denature or damage the material. In yet other embodiments, when a material is contacted with a liquid and absorbs or adsorbs a portion of the liquid, the material is considered to be in dry form when the absorbed or adsorbed liquid is removed to the extent that the material has substantially the same weight as before being contacted with the liquid. A material may be dried by physical methods (such as heating, exposure to vacuum, or exposure to gas flow) and/or chemical methods (such as chemical reactions that consume solvent).

As used herein, the term “elevated temperature” refers to a temperature that is higher than room temperature. In one embodiment, the elevated temperature is about 20-25° C. above room temperature. In another embodiment, the elevated temperature is about 20-40° C. above room temperature. In an embodiment, the elevated temperature is about 20-50° C. above room temperature. In yet another embodiment, the elevated temperature is 5° C., 10° C., 15° C., 20° C., 25° C., 30° C., 35° C., 40° C., 45° C., 50° C., 55° C., or 60° C. above room temperature. In another embodiment, the elevated temperature is any temperature above ambient temperature up to about 60° C. above ambient temperature. In yet another embodiment, the elevated temperature is any temperature above ambient temperature up to about 100° C. above ambient temperature.

As used herein, the term “monomer” refers to any discreet chemical compound of any molecular weight.

As used herein, the term “polymer” refers to a molecule composed of repeating structural units typically connected by covalent chemical bonds. The term “polymer” is also meant to include the terms copolymer and oligomers. In one embodiment, a polymer comprises a backbone (i.e., the chemical connectivity that defines the central chain of the polymer, including chemical linkages among the various polymerized monomeric units) and a side chain (i.e., the chemical connectivity that extends away from the backbone).

As used herein, the term “polymerization” or “cross-linking” refers to at least one reaction that consumes at least one functional group in a monomeric molecule (or monomer), oligomeric molecule (or oligomer) or polymeric molecule (or polymer), to create at least one chemical linkage between at least two distinct molecules (e.g., intermolecular bond), at least one chemical linkage within the same molecule (e.g., intramolecular bond), or any combinations thereof. A polymerization or cross-linking reaction may consume between about 0% and about 100% of the at least one functional group available in the system. In an embodiment, polymerization or cross-linking of at least one functional group results in about 100% consumption of the at least one functional group. In another embodiment, polymerization or cross-linking of at least one functional group results in less than about 100% consumption of the at least one functional group.

As used herein, the term “non-malleable” as relating to a state of matter refers to a state or condition of a material wherein when held under a constant strain at a constant temperature, less than 90% of the stresses within the material are relaxed within 72 hours. Further, the term “non-malleable” as relating to a material refers to a material which does not exhibit malleable behavior at any temperature at which the material is stable, i.e. not combusting or decomposing.

As used herein, the term “malleable” as relating to a state of matter refers to a state or condition of a material wherein when held under a constant strain at a constant temperature, at least 90% of the stresses within the material are relaxed within 72 hours. Further, the term “malleable” as relating to a material refers to a material that is able to become malleable when heated above its vitrimeric transition temperature.

As used herein, the term “vitrimeric transition temperature”, denoted as “Tᵥ” refers to the temperature at which a material is able to transition from the “non-malleable” state to the “malleable” state.

As used herein, the term “vitrimer” is used to describe a polymer (such as a plastic or a resin, for example) consisting of molecular, covalent networks, which can change its topology by thermally activated bond exchange reactions. At higher temperatures, vitrimers can flow like viscoelastic liquids, at low temperatures the bond exchange reactions are slow enough for the vitrimer to behave like a thermoset. In an embodiment, the temperature at which a transition between a vitrimer behaving like a thermoset and behaving like a viscoelastic liquid happens is referred to as the vitrimeric transition temperature (Tᵥ).

As used herein, and in a non-limiting sense, the term “bond exchange reaction” also referred to by its acronym as “BER”, and means that the network topology of a polymer can be rearranged due to the internal exchange of bonds between various monomers in a polymer at a high temperature and that the rearrangement substantially stops (is frozen) at a lower temperature. In an embodiment, in polymers that exhibit BER, the polymer viscosity is gradually changed versus temperature following an Arrhenius law relationship and during the rearrangement the network integrity of the polymer is maintained. In an embodiment, in a polymer that exhibits BER, because no additional monomers or termination reactions are introduced into the system, the numbers of links and average functionality of polymer chains are unchanged. In an embodiment, in polymers disclosed herein, thermally induced BER can release the internal stress of a polymer and allow the polymer to be reshaped, welded together, self-healed and reprocessed into a new shape.

As used herein, and in a non-limiting fashion, the term “topology” refers to spatial properties preserved under conditions of stretching without tearing.

As used herein, the term “viscoelastic material” is a material that exhibits at least the following properties; hysteresis is seen in a stress-strain curve, stress relaxation occurs; and creep occurs.

As used herein, the term “curable” as applied to a material refers to a material comprising at least one functional group that may undergo polymerization. The curable material may be non-polymerized (i.e., non-cured material), or may be submitted to polymerization conditions (such as chemical reagents or physical conditions) that induce polymerization of at least a fraction of the at least one polymerizable functional group (i.e., partially or fully cured material). In one embodiment, polymerization or cross-linking of the curable material results in about 100% consumption of the at least one functional group (i.e., fully cured). In another embodiment, polymerization or cross-linking of the curable material results in less than about 100% consumption of the at least one functional group (i.e., partially cured).

As used herein, the term “reaction condition” refers to a physical treatment, chemical reagent, or combination thereof, which is required or optionally required to promote a reaction. Non-limiting examples of reaction conditions are electromagnetic radiation, heat, a catalyst, a chemical reagent (such as, but not limited to, an acid, base, electrophile or nucleophile), and a buffer

As used herein, the term “reactive” as applied to amine or carbonyl groups indicate that these groups, when submitted to appropriate conditions, may take part in the reaction in question.

As used herein, the term “carbonyl monomer” corresponds to a compound comprising at least an aldehyde group [—C(══O)H] and/or at least a ketone group [R—C(══)—R], wherein each R is independently alkyl, cycloalkyl, alkenyl, cycloalkenyl, alkynyl, cycloalkynyl, aryl, heteroaryl or heterocyclyl], or a reactive oligomer or reactive polymer or pre-polymer having at least one aldehyde and/or ketone group. Suitable carbonyl monomers have one or preferably more aldehyde and/or ketone groups and may be of any molecular weight. In certain embodiments, the carbonyl monomer comprises two aldehyde groups or two keto groups. In other embodiments, the carbonyl monomer comprises three, four or more aldehyde and/or ketone groups. As used herein, a “multivalent carbonyl monomer” refers to a carbonyl monomer comprising three or more aldehyde and/or ketone groups.

As used herein, the term “aliphatic carbonyl group” as relating to a molecule refers to a molecule comprising an aldehyde and/or ketone group that is directly linked to an aliphatic group. In certain embodiments, the carbonyl monomer comprises two aliphatic aldehyde and/or ketone groups. In other embodiments, the carbonyl monomer comprises two or more aliphatic aldehyde and/or ketone groups. In yet other embodiments, the carbonyl monomer comprises three or more aliphatic aldehyde and/or ketone groups.

Examples of carbonyl monomers contemplated within the disclosure include, but are not limited to, dialdehydes (such as, but not limited to, glyoxal, malonaldehyde, glutaraldehyde, 2,3-thiophenedicarbaldehyde, 2,5-thiophene-dicarbaldehyde, 3-formylfurfural, 5-formylfurfural, 2,6-pyridinedicarboxaldehyde, 3,6-pyridinedicarboxaldehyde, 3,5-pyridinedicarboxaldehyde, isophthaldehyde, terephthaldehyde [such as 1,4-terephthalaldehyde (p-phthalaldehyde)], phthaldialdehyde, phenylglyoxal, and pyrroledicarboxaldehyde), diketones (such as, but not limited to, 2,3-butanedione, 2,4-pentanedione, 4-cyclopentene-1,3-dione, 1,3-cyclopentanedione, 1,2-benzoquinone, 1,4-benzoquinone, cyclohexanedione, 3,4-dihydroxy-3-cyclobutene-1,2-dione, 1,3-indandione, ninhydrin, 1,4-naphthoquinone, 1,2-naphthoquinone, diacetylbenzene, acenaphthenequinone, anthraquinone, and benzyl), multivalent aldehydes (such as, but not limited to, benzene-1,3,5-tricarboxaldehyde, 2,4,6-trihydroxy-1,3,5-benzenetricarboxaldehyde), multivalent ketones (such as, but not limited to, hexaketocyclohexane and 2-acetyl-1,3-cyclohexanedione), monomers comprising at least one primary amine and at least one carbonyl group (such as aminoacetophenone, 4-ethylaminoacetophenone, 4-aminobenzaldehyde, or 4-aminomethylbenzaldehyde).

As used herein, the term “amine monomer” corresponds to a compound comprising at least a primary amine group [--NH.sub.2--], or a reactive oligomer or reactive polymer or pre-polymer having at least one primary amine group. Suitable amine monomers have one or preferably more primary amine groups and may be of any molecular weight. In certain embodiments, the amine monomer comprises two primary amine groups. In other embodiments, the amine monomer comprises three, four or more primary amine groups.

As used herein, a “multivalent amine monomer” refers to an amine monomer comprising three or more primary amine groups.

As used herein, the term “aliphatic amine group” as relating to a molecule refers to a molecule comprising a primary amine group that is directly linked to an aliphatic group. In certain embodiments, the amine monomer comprises two aliphatic primary amine groups. In other embodiments, the amine monomer comprises two or more aliphatic primary amine groups.

In yet other embodiments, the amine monomer comprises three or more aliphatic primary amine groups.

Examples of amine monomers contemplated within the disclosure include, but are not limited to, diamines (such as, but not limited to, hydrazine, ethylenediamine, propylenediamine, 1,4-diaminobutane, 1,5-diaminopentane, 1,6-diaminohexane, 1,7-diaminoheptane, 1,8-diaminooctane, 1,9-diaminononane, 1,10-diaminodecane, 1,12-diaminododecane, 3,3′-diamino-N-methyl-dipropylamine, phenylenediamine, phenylenedimethylenamine, diaminocyclohexane, diaminocyclopentane, diaminocyclobutane, diaminothiophene, diaminopyridine, diaminopyrrole, diaminofuran, diaminoimidazole, diaminooxazole, 3,6,9-trioxaundecan-1,11-diamine, and diethylenetriamine) multivalent amines (such as, but not limited to, tris(2aminoethyl)amine, 3-ethylamino-1,5-diaminopentane, triaminobenzene, and triaminocyclohexane), and monomers comprising at least one primary amine and at least one carbonyl group (such as aminoacetophenone, 4-ethylaminoacetophenone, 4-aminobenzaldehyde, or 4-aminomethylbenzaldehyde).

The term “aliphatic” or “aliphatic group” as used herein means a straight-chain or branched hydrocarbon chain that is completely saturated or that contains one or more units of unsaturation, or a monocyclic hydrocarbon or bicyclic hydrocarbon that is completely saturated or that contains one or more units of unsaturation, but which is not aromatic (also referred to herein as “carbocycle” or “cycloalkyl”), that has a single point of attachment to the rest of the molecule wherein any individual ring in said bicyclic ring system has 3-7 members. For example, suitable aliphatic groups include, but are not limited to, linear or branched or alkyl, alkenyl, alkynyl groups and hybrids thereof such as (cycloalkyl)alkyl, (cycloalkenyl)alkyl or (cycloalkyl)alkenyl.

The terms “alkyl” and “alkoxy,” used alone or as part of a larger moiety include both straight and branched carbon chains. The terms “alkenyl” and “alkynyl” used alone or as part of a larger moiety shall include both straight and branched carbon chains.

The term “heteroatom” means nitrogen, oxygen, or sulfur and includes any oxidized form of nitrogen and sulfur, and the quaternized form of any basic nitrogen.

The term “aryl” used alone or in combination with other terms, refers to monocyclic, bicyclic or tricyclic carbocyclic ring systems having a total of five to fourteen ring members, wherein at least one ring in the system is aromatic and wherein each ring in the system contains 3-8 ring members. The term “aryl” may be used interchangeably with the term “aryl ring”.

The term “aralkyl” refers to an alkyl group substituted by an aryl. The term “aralkoxy” refers to an alkoxy group. The term “heterocycloalkyl,” “heterocycle,” “heterocyclyl” or “heterocyclic” as used herein means monocyclic, bicyclic or tricyclic ring systems having five to fourteen ring members in which one or more ring members is a heteroatom, wherein each ring in the system contains 3-7 ring members and is non-aromatic.

As used herein, the term “instructional material” includes a publication, a recording, a diagram, or any other medium of expression that may be used to communicate the usefulness of the compositions of the disclosure. In some instances, the instructional material may be part of a kit useful for generating a malleable polymeric composition. The instructional material of the kit may, for example, be affixed to a container that contains the compositions of the disclosure or be shipped together with a container that contains the compositions. Alternatively, the instructional material may be shipped separately from the container with the intention that the recipient uses the instructional material and the compositions cooperatively. For example, the instructional material is for use of a kit; instructions for use of the compositions; or instructions for use of a formulation of the compositions.

Throughout this disclosure, various aspects of embodiments herein may be presented in a range format. It should be understood that the description in range format is merely for convenience and brevity and should not be construed as an inflexible limitation on the scope of the disclosure. Accordingly, the description of a range should be considered to have specifically disclosed all the possible sub-ranges as well as individual numerical values within that range and, when appropriate, partial integers of the numerical values within ranges. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

### Polyimine Polymers

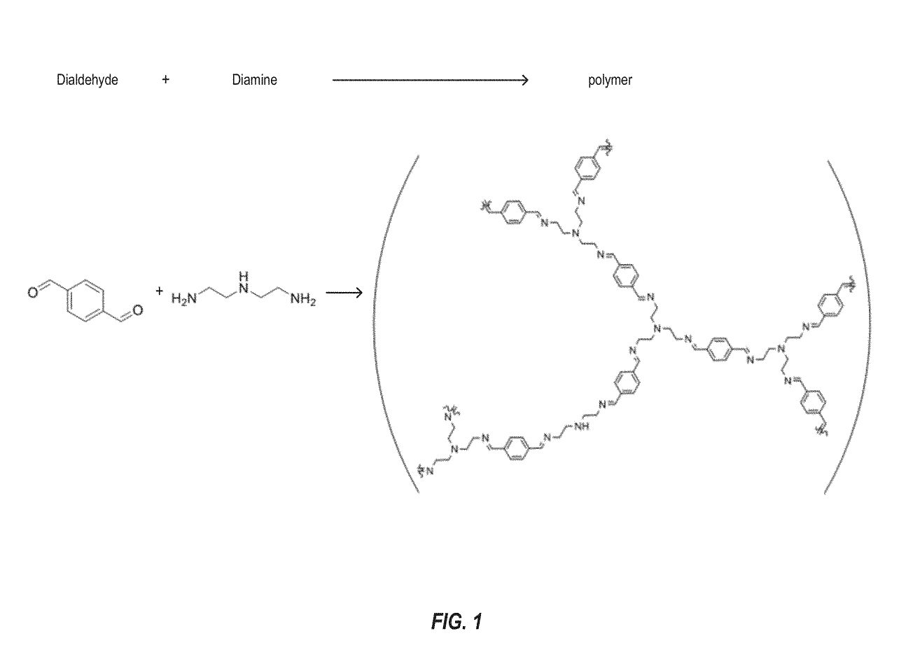

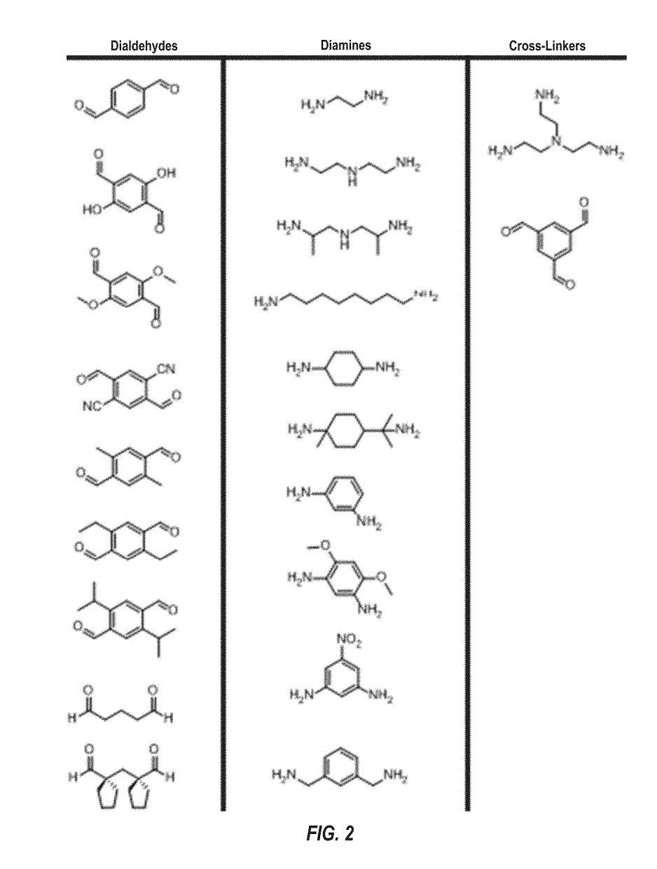

Compositions comprising polyimines are disclosed herein. In an embodiment, imine-linked polymers exhibiting dynamic imine chemistry are disclosed herein. In certain embodiments, the polyimine may be prepared from a dicarbonyl monomer, a diamine monomer, and a cross-linking agent as, for example, depicted in FIG. 1. In other embodiments, the cross-linking agent comprises a multivalent carbonyl monomer or a multivalent amine monomer. The wide variety of commercially available or easily prepared diamines, dialdehydes and diketones makes polyimines an accessible class of polymer to synthesize. A non-limiting representation of monomer diamines, dialdehydes, diketones that can be combined to make polyimines of the present disclosure is represented in FIG. 2. In an embodiment, a difunctional monomer containing, for example, a carbonyl group and a protected primary amine which could polymerize upon deprotection, can be formulated with crosslinkers to make polyimine polymers.

Table 1 lists various polymer materials and their respective Young's Modulus, Tensile Strength and Processing Temperature. In certain embodiments, the polyimines of the present disclosure are rendered malleable and properly shaped, healed or molded by application of heat and/or treatment with aqueous liquids, such as water. In other embodiments, the polyimines disclosed herein are recyclable through powder reprocessing. In an embodiment, the stress relaxation behavior of the polyimines of the disclosure has Arrhenius-like dependence on temperature.

TABLE 1

| | Young's | Tensile | Processing |
|---|---|---|---|
| | Modulus | Strength | Temperature |
| Polymer Material | (GPa) | (MPa) | (° C.) |
| HDPE | 1.0 | 20 | 180 |
| Polypropylene | 1.4 | 36 | 130 |
| Polyimine | 1.0-1.8 | 40-58 | 80 |
| Polystyrene | 1.9-2.9 | 32-46 | 240 |
| Polycarbonate | 2.0-2.4 | 55-75 | 155 |
| PET | 3.2-11.0 | 60-150 | 260 |

### Cross-Link Exchange in a Polyimine

In an embodiment, preparation of an imine-linked linear polymer comprises the combination of a diamine monomer and a dicarbonyl monomer of appropriate geometries. In a non-limiting aspect, preparation of a network polymer further comprises the use of a tri, tetra or multivalent amine monomer, or a tri, tetra or multivalent carbonyl monomer.

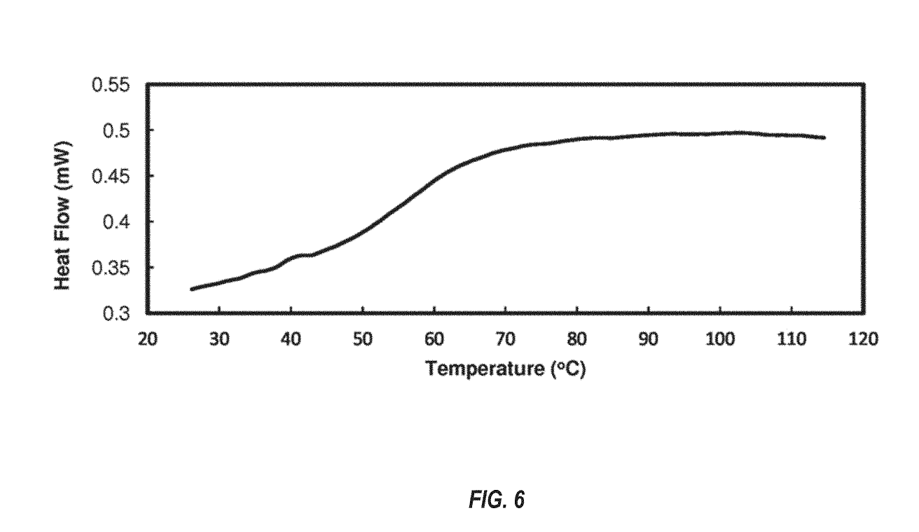

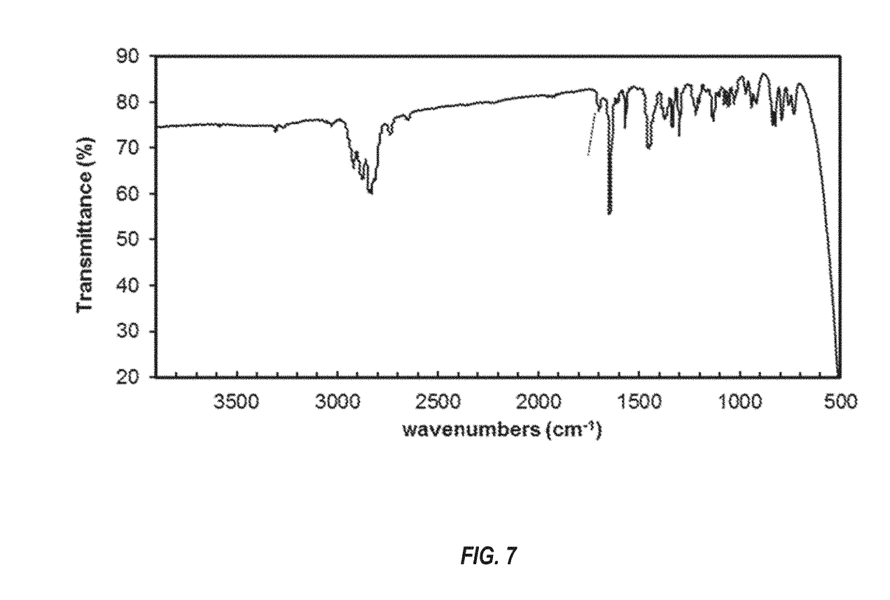

Hard polymer films were prepared using terephthaldehyde as the dialdehyde monomer, and diethylenetriamine as a diamine monomer. As depicted in FIG. 1, tris(2aminoethyl)amine can be used as a triamine cross-linker. In an embodiment, the resulting polymine polymer had a yellow to orange color, was translucent, and has a measured glass transition temperature (T_{g}) of 56° C. as depicted in FIG. 6. The polymerization reaction was observed by infrared spectroscopy to consume the aldehyde end groups, which had a characteristic C══O stretch at 1,692 cm⁻¹ while forming imine links which C══N stretch was observed at 1,644 cm⁻¹, see FIG. 7.

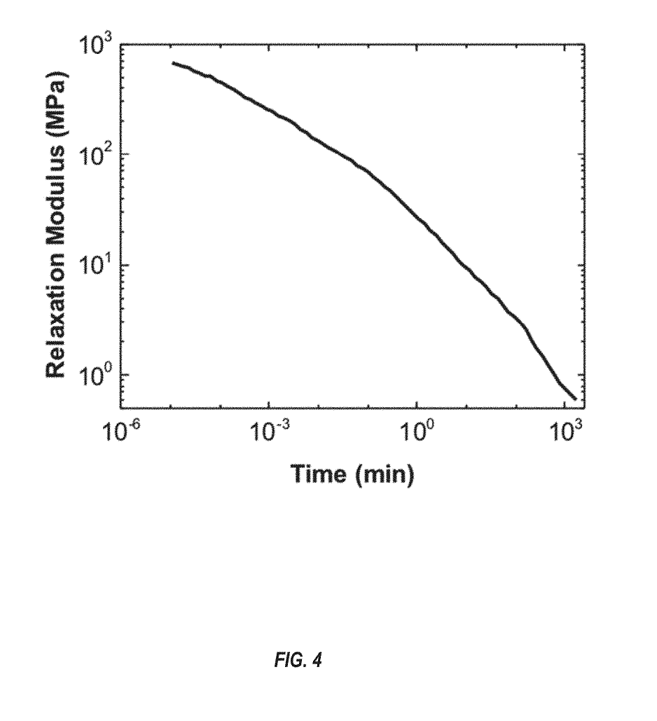

Using a stress relaxation experiment, the polyimine was found to relax stress in the solid state through reversible bond exchange reactions. The stress relaxation experiment involved applying a 1% elongation to the polymer material and then monitoring the stress required to maintain that elongation over time. If the cross-links were able to exchange, the time it took for the stress in the polymer to dissipate would be a function of the bond exchange reaction rate. As depicted in FIG. 4, the polyimine was observed to relax away nearly all stress in less than 30 min at 90° C. By performing stress relaxation testing at various temperatures, a temperature-time superposition (TTSP) plot was constructed.

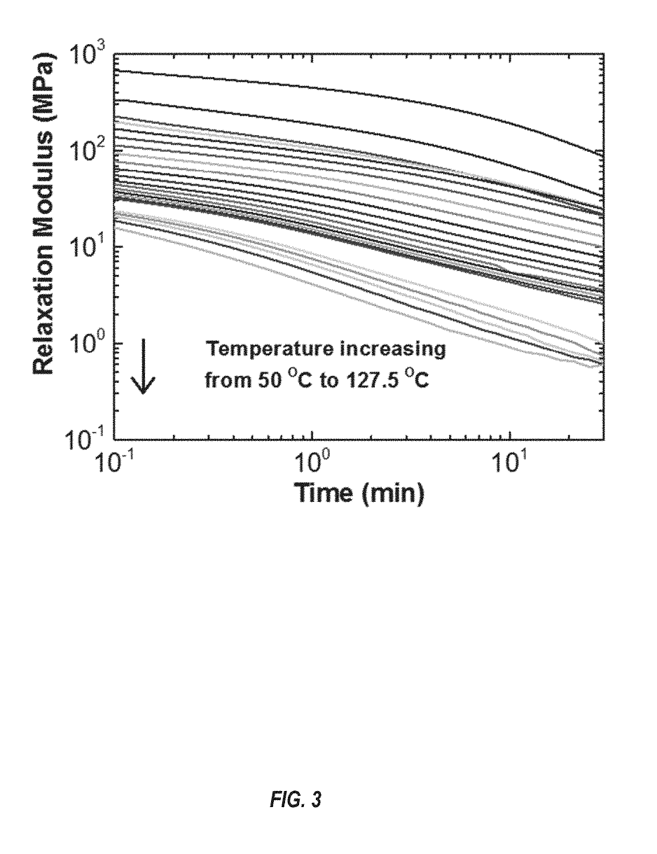

As depicted in FIG. 3, the polyimine's stress relaxation behavior exhibited Arrhenius-like dependence on temperature. FIG. 4 depicts the results of a 30 min stress-relaxation experiment that was performed on the same sample at several temperatures. All of the resulting curves were found to be shifted iterations of a reference, or master curve as depicted in FIG. 4.

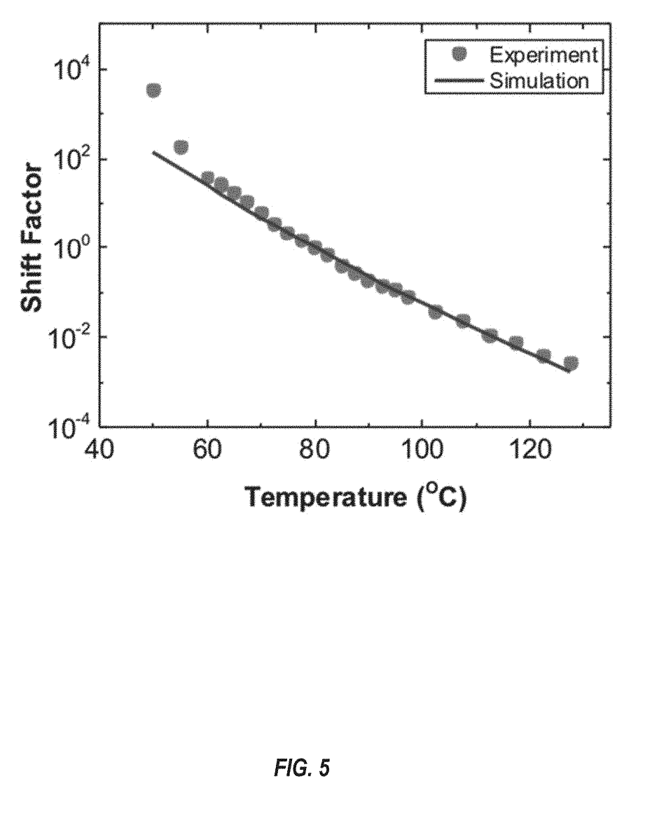

As depicted in FIG. 5, by measuring the shift factor needed for each temperature against a reference temperature, it was possible to confirm that the extrapolated (calculated) temperature-dependent rate of stress relaxation closely correlates to experimental results. Using the extrapolation, it was possible to calculate that, while it takes 30 min for 89% of the stress to be relaxed at 80° C., the same process would take about 480 days at room temperature. Without being bound by theory, this result indicates that the polyimine is expected to mimic a classic thermoset at ambient temperatures and short time scales (hours to weeks), and thus the reversible bonds would not compromise the material's utility for potential practical applications. However, unlike epoxy-acid polymers, whose transesterification reactions require a catalyst for appreciable bond-exchange at reasonable temperatures (as high as 180° C.), the imine exchange reaction was found to relax stress at easily obtainable elevated temperatures (such as those above room temperature but below about 100° C.) without the expense or complication of an added catalyst.

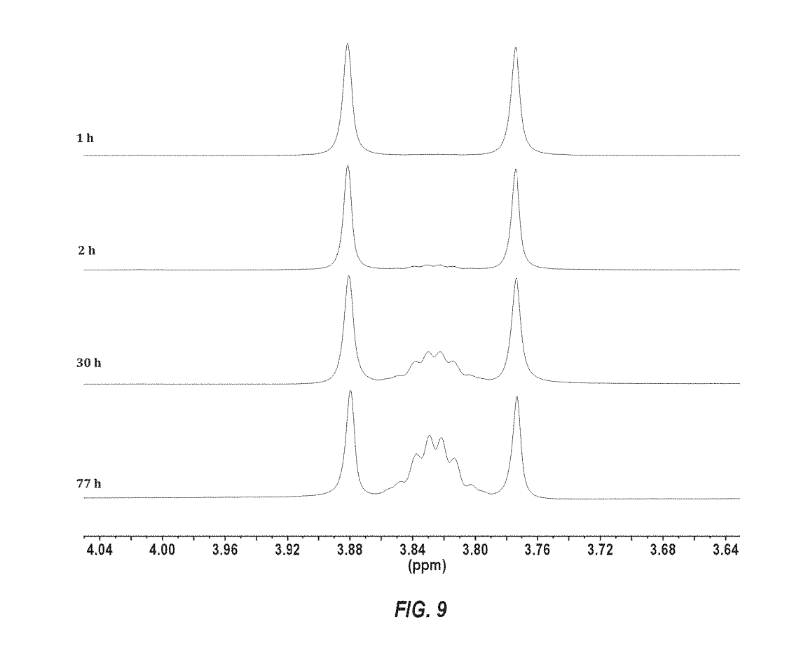

To verify that stress-relaxation in the bulk polymer occurs as a result of imine exchange, a small molecule model study was performed. By direct ¹H NMR observation of the formation of a new imine species subsequent to the mixing of two parent imine molecules aa and bb as depicted in Scheme 2. The relative rate of imine exchange vs. temperature was then observed, see FIG. 9.

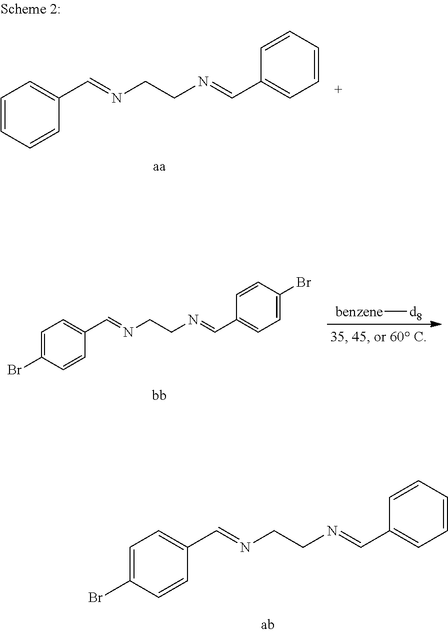

In order to directly observe the behavior of the imine exchange reaction in a non-equilibrium system, and as depicted in Scheme 2, compounds aa and bb were mixed in deuterated benzene, and the formation of ab was monitored by ¹H NMR spectroscopy over time at three different temperatures: 35° C., 45° C., and 60° C. The sample was prepared by mixing 1:1 molar ratio of aa and bb in benzene-d6.

The ¹H NMR signal for the methylene groups in aa and bb appeared as singlets at 3.98 ppm and 3.87 ppm, respectively, in CDCl₃. The methylene signal of ab was a multiplet at 3.825 ppm (in C₆D₆). FIG. 9 shows the time-dependent NMR spectrum of the sample recorded at 35° C. The gradual increase of the peak at 3.825 ppm was observed, which corresponds to the methylene group of ab.

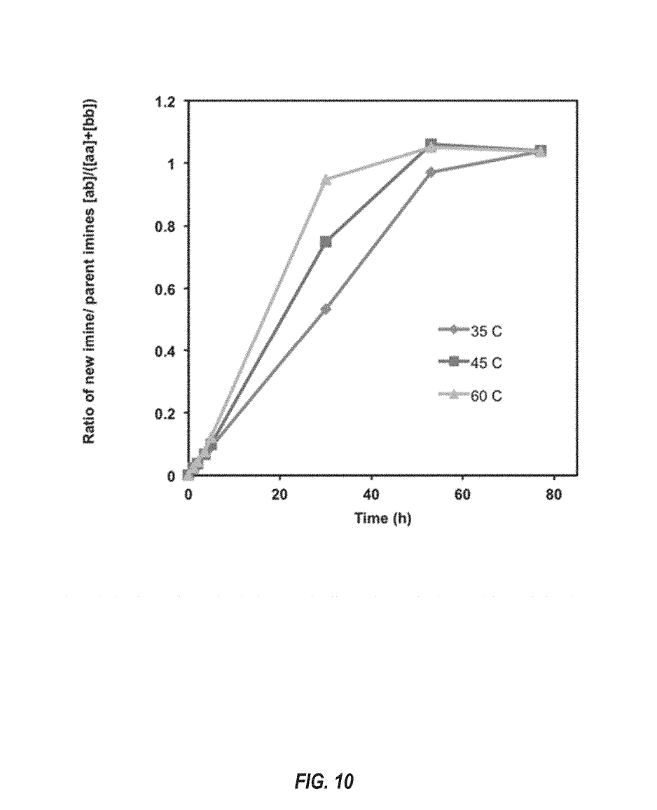

FIG. 10 depicts a plot of the ratio of the integration of the methylene peaks of the new imine versus parent imines over time at various temperatures. FIG. 10 shows that the rate of the imine exchange reaction varied with temperature. The 60° C. sample reached equilibrium most quickly, and the 35° C. sample took the longest. This model study supports that the temperature-dependent rate of the imine exchange reaction is responsible for the temperature-dependent malleability of the polyimine

The time required to reach the equilibrium concentration of the new imine can be seen as analogous to the relaxation time of a polymer under mechanical stress. Without being bound by theory, although the conditions in the bulk polymer are distinct from those of small molecules in solution, the model study shows that imine exchange reactions are a primary temperature-dependent mechanism for stress-relaxation and self-healing within the polyimine polymer.

### Monomers

In an embodiment, a dicarbonyl monomer may comprise at least one aliphatic carbonyl group and/or aromatic carbonyl group. In specific embodiments, the dicarbonyl monomer useful within the disclosure comprises at least one aromatic aldehyde and/ketone group. In other specific embodiments, the dicarbonyl monomer useful within the disclosure comprises at least one aromatic aldehyde group. Examples of dicarbonyl monomers contemplated within the disclosure include, but are not limited to, dialdehydes (such as, but not limited to, glyoxal, malonaldehyde, glutaraldehyde, 2,3-thiophenedicarbaldehyde, 2,5-thiophenedicarbaldehyde, 3-formylfurfural, 5-formylfurfural, 2,6-pyridinedicarboxaldehyde, 3,6-pyridinedicarboxaldehyde, 3,5-pyridinedicarboxaldehyde, isophthaldehyde, terephthaldehyde [such as 1,4-terephthalaldehyde (p-phthalaldehyde)], phthaldialdehyde, phenylglyoxal, and pyrroledicarboxaldehyde), and diketones (such as, but not limited to, 2,3-butanedione, 2,4-pentanedione, 4-cyclopentene-1,3-dione, 1,3-cyclopentanedione, 1,2-benzoquinone, 1,4-benzoquinone, cyclohexanedione, 3,4-dihydroxy-3-cyclobutene-1,2-dione, 1,3-indandione, ninhydrin, 1,4-naphthoquinone, 1,2-naphthoquinone, diacetylbenzene, acenaphthenequinone, anthraquinone, and benzyl). In an embodiment, a diamine monomer may comprise at least one aliphatic primary amine group and/or aromatic primary amine group. In specific embodiments, the diamine monomer comprises at least one aliphatic amine group.

Examples of diamine monomers include, but are not limited to, hydrazine, ethylenediamine, propylenediamine, 1,4-diaminobutane, 1,5-diaminopentane, 1,6-diaminohexane, 1,7-diaminoheptane, 1,8-diaminooctane, 1,9-diaminononane, 1,10-diaminodecane, 1,12-diaminododecane, 3,3′-diamino-N-methyl-dipropylamine, phenylenediamine, phenylenedimethylenamine, diaminocyclohexane, diaminocyclopentane, diaminocyclobutane, diaminothiophene, diaminopyridine, diaminopyrrole, diaminofuran, diaminoimidazole, diaminooxazole, 3,6,9-trioxaundecan-1,11-diamine, and diethylenetriamine

In an embodiment, a cross-linking agent is disclosed that comprises a multivalent carbonyl monomer or a multivalent amine monomer.

Examples of multivalent amine monomers contemplated within the disclosure include, but are not limited to, tris(2aminoethyl)amine, 3-ethylamino-1,5-diaminopentane, triaminobenzene, and triaminocyclohexane.

Examples of multivalent carbonyl monomers contemplated within the disclosure include, but are not limited to, multivalent aldehydes (such as, but not limited to, benzene-1,3,5-tricarboxaldehyde, 2,4,6-trihydroxy-1,3,5-benzenetricarboxaldehyde), and multivalent ketones (such as, but not limited to, hexaketocyclohexane, and 2-acetyl-1,3-cyclohexanedione).

Examples of monomers comprising at least one primary amine and at least one carbonyl group contemplated within the disclosure include, but are not limited to, aminoacetophenone, 4-ethylaminoacetophenone, 4-aminobenzaldehyde, or 4-aminomethylbenzaldehyde.

In an embodiment, polyimines disclosed herein may be prepared by contacting at least one dicarbonyl monomer, at least one diamine monomer, and at least one cross-linking agent in a system, such as a solution. These reagents may be added at the same time to the system, or may be added sequentially or in any order contemplated by those skilled in the art. In certain embodiments, the at least one dicarbonyl monomer, the at least one diamine monomer, and the at least one cross-linking agent are contacted under conditions that favor loss of water derived from the imine group formation. Non-limiting examples of those conditions include solvent removal, solvent extraction, precipitation, open air evaporation, lyophilization and the like.

In an embodiment, imine linked polymers disclosed herein comprise at least one dicarbonyl monomer, at least one diamine monomer, and at least one triamine crosslinking agent present in molar equivalents from about 1:0.99:0.0067 to about 1:0.01:0.66, respectively. In another embodiment, a tricarbonyl crosslinking agent may be used whereby the molar equivalent ratios present may be about 1:0.99:0.0067 to about 1:0.01:0.66 that correspond to ratios of diamine monomer to dicarbonyl monomer to tricarbonyl crosslinker.

In another embodiment, the crosslinking agent is a tetraamine, pentaamine or greater valency amine, in which case a more general representation may be achieved by expressing the molar equivalent ratios in terms of molecular weight/functional group such that the molecular weight is divided by the number of participating functional groups (such as the number of carbonyl groups in the monomer, or the number of primary amines present in the monomer). In such a case, the molar ratios of functional groups can be directly expressed as being present from 1:0.99:0.01 to 1:0.01:0.99 corresponding to ratios of carbonyl groups from dicarbonyl monomers to amine groups from diamine monomers to amine groups from multivalent amine monomers. In an embodiment, a crosslinking agent can be a multivalent carbonyl monomer so that the molar ratios of functional groups can be directly expressed as being present from 1:0.99:0.01 to 1:0.01:0.99 corresponding to ratios of amine groups from diamine monomers to carbonyl groups from dicarbonyl monomers to carbonyl groups from multivalent carbonyl monomers.

In another embodiment, the above-mentioned ratios may be altered such that the total number of carbonyl groups in the system is not equal to the total number of amine groups in the system. This may be done to alter the malleable properties of the resulting polyimine, or may be done to achieve some other goals, such as obtaining excess binding sites for linkers involving non-imine chemistries, or obtaining excess amines for binding of inorganic species such as nanoparticles, metal ions, for example, or other specific purpose. In another case, more than one crosslinking agent may be used, or more than one diamine or dicarbonyl monomers may be used. In such cases, the total number of primary amine functional groups may be about equal to the total number of carbonyl functional groups in the system, unless it may be desirable to incorporate an excess of carbonyl groups, or an excess of primary amine groups.

In an embodiment, a monomer comprising at least one primary amine and at least one carbonyl group is incorporated into polymers disclosed herein. In such cases, further diamine monomers, dialdehyde monomers, and crosslinking monomers may be included in the system in order to achieve various properties or results. Non-limiting examples of such difunctional monomers include aminoacetophenone, 4-ethylaminoacetophenone, 4-aminobenzaldehyde, or 4-aminomethylbenzaldehyde. In such cases, it should still be maintained that the total number of primary amine groups in the system is about equal to the total number of carbonyl groups in the system, unless for a distinct specific purpose it is desirable to incorporate an excess of carbonyl groups, or an excess of primary amine groups.

In certain embodiments, preparation of the polyimines of the disclosure further require at least one catalyst, wherein the catalyst comprises an acid, a base, an electrophile or a nucleophile. In other embodiments, the at least one catalyst catalyzes the formation of the imine groups. In another embodiment, the at least one catalyst is subsequently removed from the system once the imine groups are formed.

The kinetics of the imine-exchange reactions (especially transimination and imine formation/hydrolysis) is a major contributing factor to the thermo-mechanical properties of polyimine materials. Molecular-level affects on BER kinetics leads to tunability of the vitrimeric transition temperature (Tᵥ) of the polyimine material. By altering the electrophilicity of the aldehyde, or the nucleophilicity of the amine, one can tune the thermodynamic stability as well as kinetic relaxation behavior of the resulting polyimine. Thus, in an embodiment, a small library of diamine and dialdehyde monomers could be generated to probe the relative effects of electronics and sterics upon imine exchange reactions in small molecule systems. In an embodiment, the monomers may be used to make bulk polymers.

For each of the monomers described above, a small molecule-based model compound can be prepared. Each model compound can be used in an imine exchange experiment wherein the rate of imine exchange is measured as shown below Scheme 2 which is a representative example of model studies for both a dialdehyde monomer and a diamine monomer.

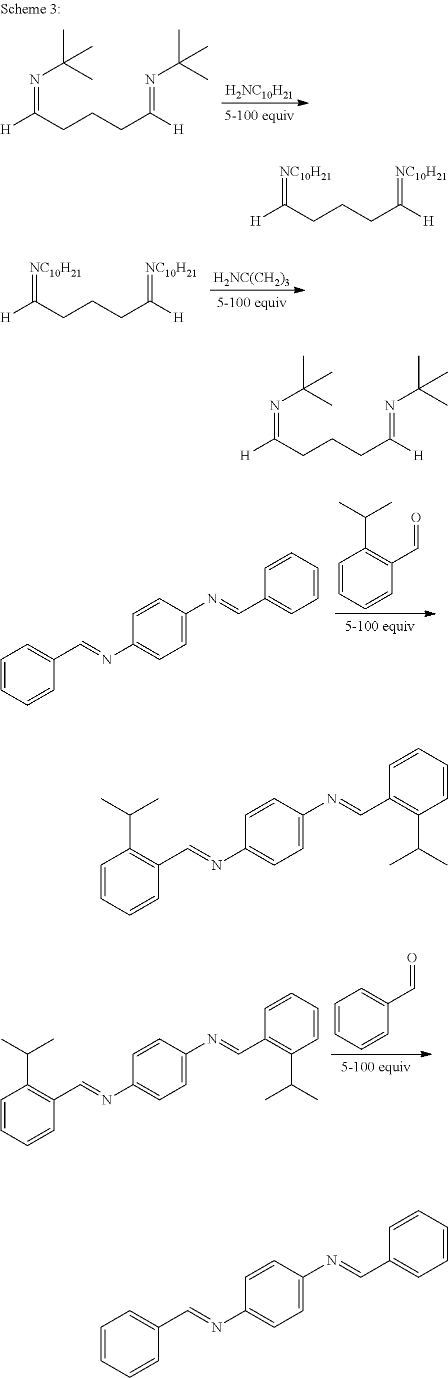

In an embodiment, monomers as depicted in FIG. 2 could be used to generate polyimines The majority of the monomers are commercially available, though some would require a short synthesis. These monomers would be used to study the relative effects of sterics and electronics on the BER kinetics of polyimines Nine dialdehydes can be used including aromatic dialdehydes with electron donating groups, electron withdrawing groups, and various bulky groups, as well as aliphatic dialdehydes with varying steric bulk. Similarly, ten diamines can be used including aliphatic diamines with varying steric bulk, aromatic diamines with electron withdrawing groups, electron donating groups, and a benzylic diamine A triamine crosslinker, and a trialdehyde crosslinker can be used to prepare the network polymers.

In an embodiment, the diamine and dicarbonyl linkers can be varied separately. A polymer can be made for each of the dialdehydes and diones using 30 mol % diethylenetriamine and 70 mol % (per reactive site) tris(aminoethyl)amine as the crosslinker. Similarly, a polymer could be prepared using each of the diamines using 30 mol % terephthaldehyde and 70 mol % (per reactive site) of 1,3,5-benzenetricarboxaldehyde. Each of the polymers synthesized could be mechanically evaluated using stress-strain tests, and their BER kinetics can be measured by stress relaxation testing over a range of temperatures. The polymer molecular weight could then be determined by end group analysis using ¹H-NMR spectroscopy. The imine condensation reaction in the polymers would also be able to be confirmed by FTIR spectroscopy.

In an embodiment, in each experiment, a di-imine will be prepared first from the monomer, and then added to the solution with a 5.times.-100.times. excess of another molecule that will undergo transimination with the monomer to form another di-imine

The reaction will be monitored by gel permeation chromatography (GPC) and ¹H-NMR spectroscopy. The rate can be determined by the time required for the transimination reaction to reach equilibrium. The second di-imine can also be synthesized then converted to the first di-mine by the same method, and thus the rate of the reverse reaction will also be measured. This experiment could be repeated for all of the monomers listed above. In an embodiment, all the diamine monomers can be reacted with benzaldehyde and 2-isopropylbenzaldehyde respectively, and all of the dialdehydes could be reacted with tertbutylamine and decylamine respectively.

The results of the model studies would then be compared with those of the BER kinetics measurements of the polymers. The transiminstion reaction rates of the model compounds are expected to follow a similar trend as observed in the BER kinetics of the polymers.

For each of the monomers described above, a small molecule-based model compound will also be prepared, and used in an imine exchange experiment wherein the equilibrium concentrations of two different imine-linked molecules can be measured.

In an embodiment, the reaction depicted in Scheme 4 represents a pair of competing aldehydes and a pair of amines In each experiment, either benzaldehyde could be added to a mixture of two amines, or hexylamine could be added to a solution of two aldehydes. In each case two different imines will be formed as shown in Scheme 4. The reaction solution would be heated until the equilibrium concentration is reached. This equilibrium concentration could be characterized by ¹H-NMR spectroscopy. The reactants that would be used are the monofunctional equivalents of the compounds in the monomer library depicted in FIG. 2 and as described above.

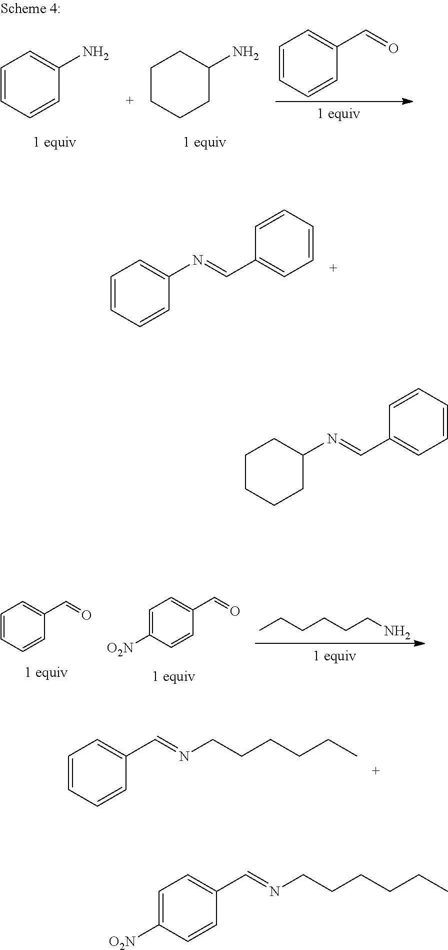

### Methods of Making Polyimine Polymers

Methods of preparing polyimine polymers as disclosed herein include, but are not limited to, the following embodiments. In an embodiment, the method comprises the steps of contacting the polymer with an aqueous liquid, and converting the resulting material into dry form. In another embodiment, the method comprises the steps of heating the powdered polymer to an elevated temperature, and cooling the resulting material to room temperature. In yet another embodiment, a method of reprocessing or repurposing a polyimine polymer is disclosed.

In certain embodiments, a method for making the polyimine polymers disclosed herein comprises contacting at least one dicarbonyl monomer, at least one diamine monomer, and at least one cross-linking agent in a system, whereby the composition comprising the polyimine polymer is prepared. In other embodiments, the at least one dicarbonyl monomer, the at least one diamine monomer, and the at least one cross-linking agent are contacted approximately simultaneously in the system. In yet other embodiments, a mixture of the at least one diamine monomer and the at least one cross-linking agent is contacted with the at least one dicarbonyl monomer. In yet other embodiments, the method for making polyimine polymers further comprises removing at least a portion of the water present in the system.

### DMA Stress Relaxation:

The time and temperature dependent relaxation modulus of the polyimine polymer was also tested on the DMA machine (Model Q800, TA Instruments, New Castle, Del., USA). During the test, a polymer sample with the same dimensions mentioned above was initially preloaded by 1×10⁻⁴³ N force to maintain straightness. After reaching the testing temperature, it was allowed 30 min to reach thermal equilibrium. The specimen was stretched by 1% on the DMA machine and the deformation was maintained throughout the test. The decrease of stress was recorded and the stress relaxation modulus was calculated. FIG. 3 depicts the results of relaxation tests of a polyimine polymer as disclosed herein, at 21 distinct temperatures between 50° C. and 127.5° C. on a double logarithmic plot.

Selecting 80° C. as a reference temperature (Tᵣ), each modulus curve in FIG. 3 was shifted horizontally to overlap with the next. This produced the master relaxation curve shown in FIG. 4, which spans many decades of modulus (from ˜676 MPa to ˜0.59 MPa) and represents the actual relaxation behavior of the polymer within a long time scale (1670 min, around ˜27.9 h) at 80° C. The corresponding shift factors are also plotted against temperature in FIG. 5.

The master relaxation curve of polymine polymers disclosed herein, e.g. FIG. 4, suggests that the kinetics of the BER induced stress relaxation follows the well-known temperature-time superposition (TTSP) principles. To quantitatively study the relaxation behavior, the following definition of relaxation modulus was used (Capelot, et al., 2012, ACS Macro Lett. 1:789; Montarnal, et al., 2011, Science 334:965; Capelot, et al., 2012, J. Am. Chem. Soc. 134:7664; Long, et al., 2013, Soft Matter 9:4083).

$$τ = \frac{1}{k} exp ( \frac{{E}_{a}}{RT} ) \qquad Equation 1$$

where k is a kinetic coefficient (k>0) R is the gas constant of 8.314461/Kmol, and Eₐ is the activation energy.

The shift factor, namely the ratio between the temperature dependent relaxation time and the relaxation time at a reference temperature T.sub.n is therefore expressed as:

$$A = exp [ \frac{{E}_{a}}{RT} ( \frac{1}{T} - \frac{1}{{T}_{r}} ) ] \qquad Equation 2$$

The predicted shift factors of the relaxation curves are also plotted in FIG. 5 to compare with the experimental data. An Arrhenius-type dependence on temperature was revealed. By further examination of Equation 2, it was found that in the semi-log scale the energy barrier could be determined by the slope of the shift factor curve. As depicted in FIG. 3, by measuring the curve slope (18886/K), the energy barrier Eₐ is calculated to be 157.02 kJ/mol.

### Material Testing Machine for Compressing the Powder

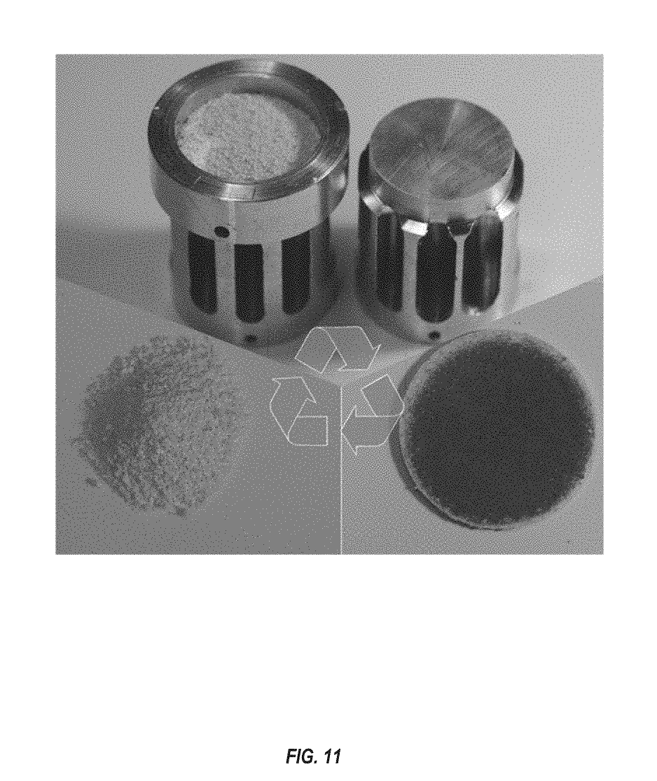

An aluminum punch mold was machined on a lathe. Since the rate of imine exchange is thermally sensitive, it is important to precisely control the sample temperature during the tests. The specially designed aluminum punch mold is shown in FIG. 11, where three hollow slots were machined in the platen to improve the thermal convective properties and temperature distribution during heating. After placing polymer powder into the mold (FIG. 11), it was then transferred into a customized thermal chamber for heating, while the applied pressure is controlled by a universal material testing machine (MTS, Model Insight 10, Eden Prairie, Minn., USA). The temperature in the thermal chamber manufactured by Thermocraft (Model LBO, Winston Salem, N.C., USA) was controlled with a Eurotherm controller (Model Euro 2404, N. Chesterfield, Va., USA) where a built-in electrical heater with a fan and an externally attached tank of liquid nitrogen provide the heat and cooling.

### Recycling Study

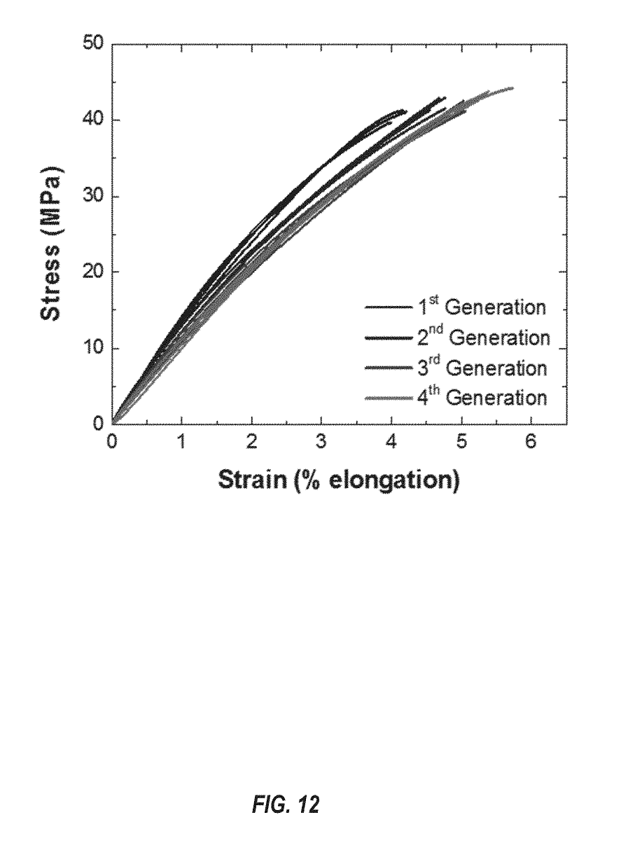

In an embodiment, polyimine polymers disclosed herein may be recycled and reused in new applications with little to no loss in the properties of the starting, pre-recycled, polymer even after several cycles of recycling. After confirming the fundamental malleable behavior of the polyimine, the recyclability of the material was investigated. The durability of the imine-linked polymer was investigated toward complete reprocessing from powder to solid. For this purpose, the polymer powder was obtained by performing the polymerization in ethyl acetate, and collecting the precipitate. The powder was pressed in an aluminum mold under 90 kPa for 45 min at 80° C., see FIG. 11. This process resulted in the formation of a solid translucent polymer disc, see FIG. 11. The stress-strain behavior of the polymer disc is illustrated as the ‘first generation’ curve in FIG. 12. The disc was subsequently ground into a fine powder (FIG. 11) using sand paper, and the recycling process was repeated three times to yield the other curves in FIG. 12.

FIG. 12 shows that the polymer has excellent recyclability through four generations of recycling. There was a slight shift observed in the polymer's mechanical properties as it is reprocessed. Without being bound by theory, because the polymer's elastic modulus tended to decrease through the first few recycling generations, the polymer appeared to become less stiff and more flexible as it was recycled. Also, there was no loss in the tensile strength (stress at break) of the polymer, but rather a slight increase is observed in the 4th generation curves of FIG. 12. This behavior would be impossible for a traditional thermoset polymer, since a significant percentage of covalent bonds would be broken irreversibly upon grinding the material into a powder. In the polyimine however, the bonds are able to reform through exchange upon heating (even in the absence of a catalyst), and the polymer is observed to completely regain its original strength. Whenever a catalyst is incorporated into a polymer in order to promote reversibility, the catalyst's active lifetime will limit the polymer's reprocessability. In the case of catalyst free polyimines, there was no observed degradation of the polymer properties through four generations of recycling, indicating that the imine bond was resilient against recycling fatigue.

### Mechanical Properties of Fresh Polymer Film

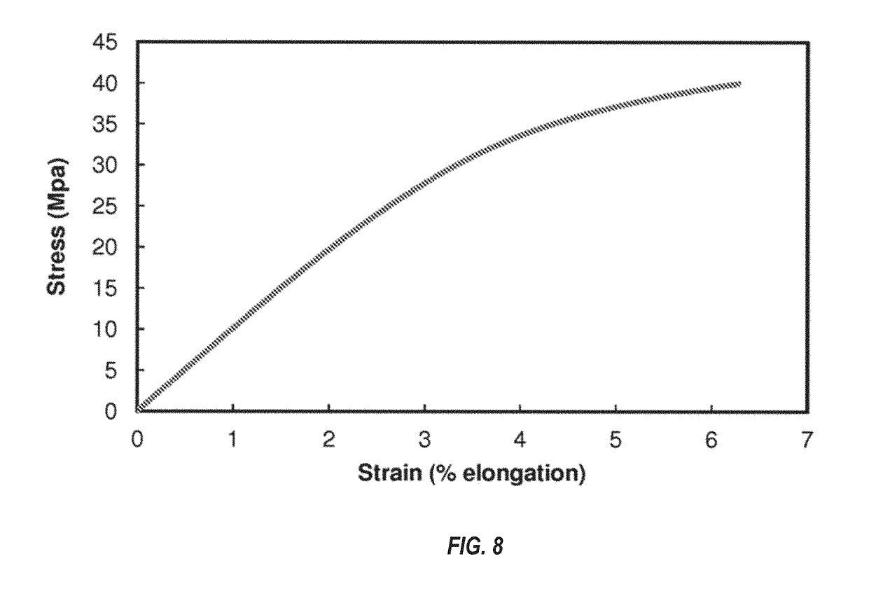

In an embodiment, a polyimine film was made for mechanical testing by using commercially available starting materials. The glassy polymer films were prepared using terephthaldehyde as the dialdehyde, and diethylenetriamine as a diamino linker. Tris(2-aminoethyl)amine was used as a triamino crosslinker. The cross-linked polyimine undergoes a malleable phase transition at elevated temperature, and is able to relax stress in the solid state through reversible bond exchange reactions. This behavior was confirmed by stress-relaxation testing on a tensile testing instrument, the results of which are depicted in FIG. 8. The polyimine is observed to relax away 90% of its stress within 30 min at 80° C. This enables reprocessing of the material from powder to coherent solid by simply applying mild heat and pressure Inn an embodiment, and as depicted in FIG. 11, the polymer was ground to powder, and pressed into a film sequentially through four generations of recycling without any loss of tensile strength.

The freshly prepared polymer film sample was characterized by a stress strain experiment. In an embodiment, the curve in FIG. 8 represents the typical stress strain performance for the polyimine: elastic modulus .about.1 GPa, stress at break .about.40 MPa, elongation at break between 4 and 7%.

In another embodiment, a polyimine powder was prepared by predissolving each of the monomers in the same stoichiometric ratios in ethyl acetate, and adding the resulting solutions together in an open vessel at 85° C. in a fume hood. When the ethyl acetate was evaporated, the polymer powder was left behind.

### Swelling and Drying Study

The dependence of thermo-moisture-mechanical properties of the bulk polyimine materials on the thermodynamic stability of imine linkages could be determined through swelling and drying of the polyimine polymers in various ethereal and aqueous solvents.

Without being bound by theory, if thermodynamic equilibrium is reached significantly more quickly in the presence of water, then it might mean that the chemical effect of the water is important independent of physical plasticizing effect of the polymer being swollen by uptake of water molecules.

In another embodiment, ethereal solvents such as dioxane, diethyl ether, and tetrahydrofuran could be used to swell polyimine material made from monomers used to test the rate of imine exchange in the presence of water. Weight and volume measurements could be taken to determine the extent of solvent-uptake. Additionally, stress-relaxation rates within the solvent containing polymers could be compared with the rates observed in the dry polymers, and then compared with the relaxation rate of the polymers when soaked with water.

In an embodiment, the thermodynamic stabilities of various imine bonds vs. hydrolysis of polyimine polymers disclosed herein could be determined. The impact of imine linkage thermodynamic stabilities on bulk polymer properties including mechanical properties and thermal stability would also be determined. The concentrations of di-imine molecules at thermodynamic equilibrium, resulting from competing pairs of monomers, could be measured. These results could be correlated to the measured thermal stabilities and mechanical properties of polymer materials.

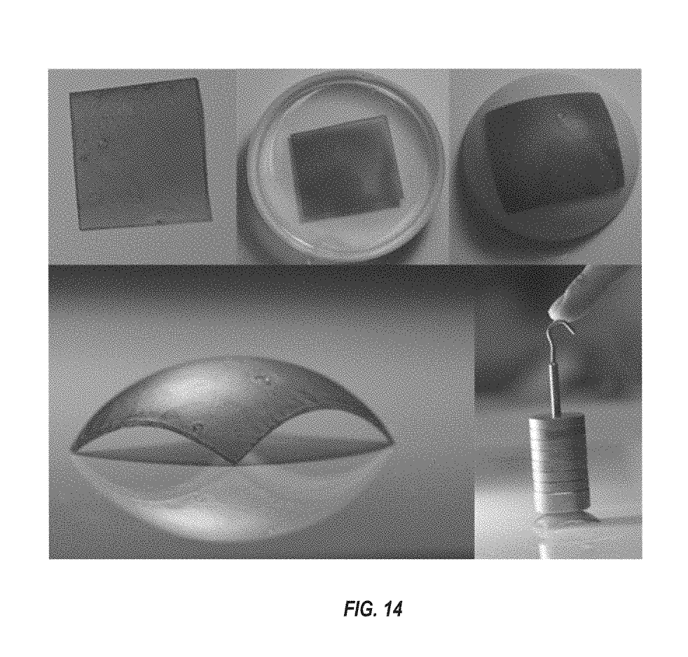

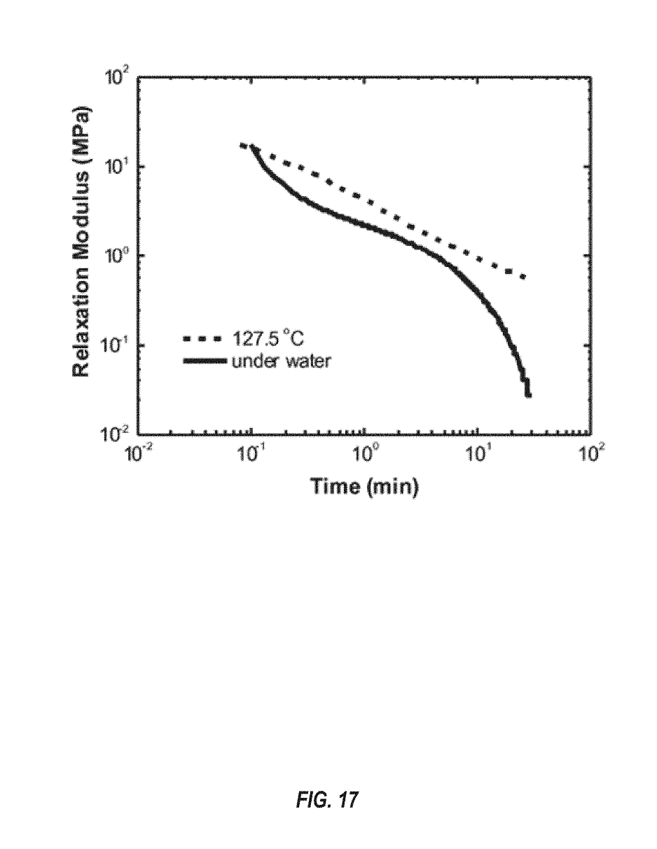

In an embodiment, the sensitivity of polyimine polymers to moisture was investigated. Upon exposure to water, the hard glassy polymer became elastomeric and flexible as it swelled and reached saturation, see FIGS. 14 and 17, for example. The polymer retained its mechanical integrity even after spending several weeks immersed in tap water.

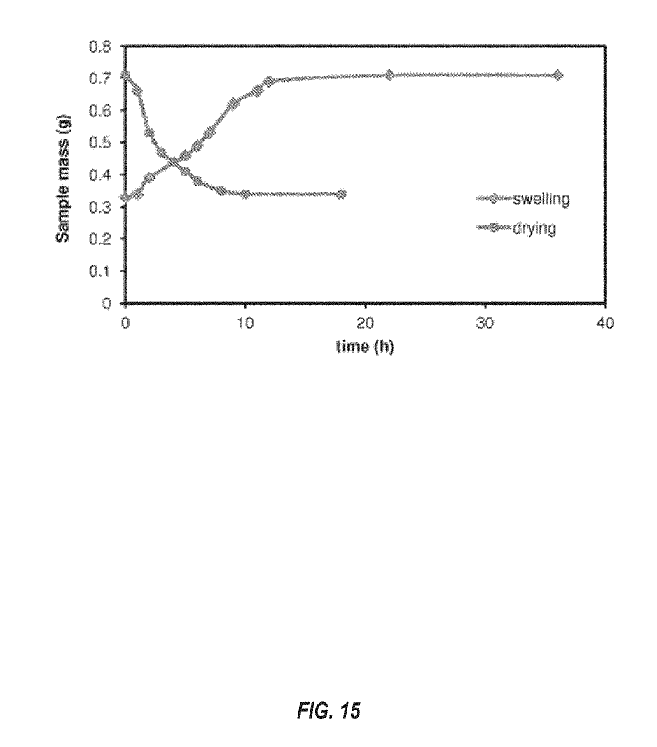

In an embodiment, a polyimine polymer, such as that depicted in FIG. 14, was observed to absorb liquid water and swell to a saturation point. The time required to fully saturate the polymer in water was approximately equal to the time required to fully dry the sample in a plastic zip bag with drying agent for about 24 h. In an embodiment, FIG. 15 shows that the material is stable in water and the swelling stays constant beyond the saturation point.

### Mechanical Response to Atmospheric Humidity

A custom-built humidity chamber using an ultrasonic humidifier with two in-line condensing chambers was used for the following measurements. The humidity level was monitored by an AcuRite 613 Indoor Humidity Monitor, which tracked the 24 hour high and low humidity readings, confirming that the humidity level was maintained at ±5% of the reported value. All of the experiments were performed at 21±1° C. at an elevation of 1,655 m above sea level. For each humidity level, the polymer film samples were kept at the designated humidity level for 24 hours, and each sample was submitted to a stress-strain test on the DMA machine immediately after removal (stress-strain experimental details elsewhere herein).

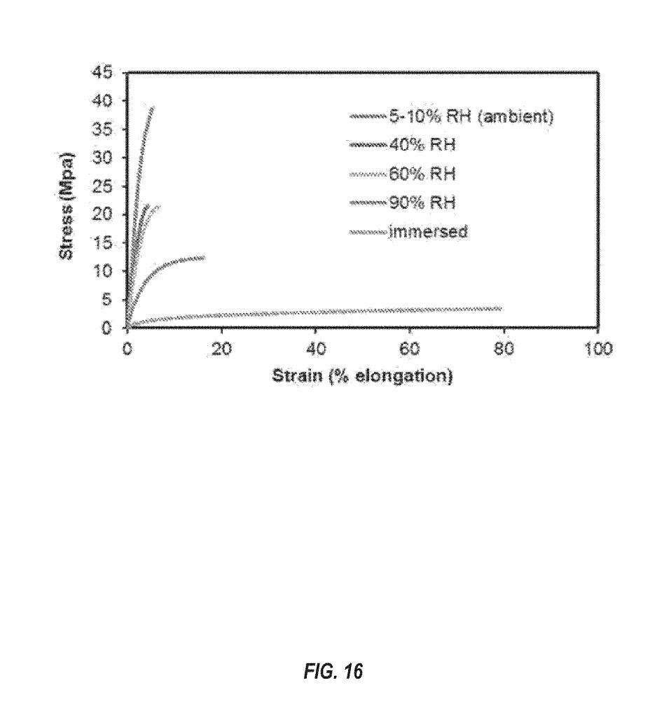

The results as depicted in FIG. 16 demonstrate an incremental softening of the material with increasing atmospheric humidity. Thus, like wood, the polyimine material became more pliable with increasing atmospheric humidity. Significantly, even at very high humidity levels, the polymer's mechanical properties are drastically different from those of the polymer saturated with water.

### Water Driven Self-Healing

In an embodiment, a catalyst-free network polyimine material is disclosed that exhibits Arrhenius-like malleability in response to heat due to imine exchange reactions within the polymer. In another embodiment, a catalyst-free network polyimine material is disclosed that exhibits processability/malleability after being immersed in water. This means the polyimine polymer can be re-shaped, or fully recycled by simply processing with water and mild pressure.

Though imine bonds are notorious for their tendency to hydrolyze in the presence of water, by careful choice of monomers, a polymer that maintains its mechanical integrity after many weeks of immersion was prepared. Not being bound by theory, in polyimine polymers disclosed herein, water facilitates bond exchange and stress relaxation within the polymer at a room temperature rate equal to that obtained by heating the dry material above room temperature. Without being limited by theory, the nature of the mechanism of water-induced imine-exchange may be through primarily a plasticizing (mechanical) effect, or through a slight hydrolysis with fast exchange chemical effect. In an embodiment, the water-induced imine-exchange effect is modulated by pH. In another embodiment, the water-induced imine-exchange effect can be tuned by rational design of a polyimine that modifies the hydrolytic stability of a bulk material as well as the macromolecular details of network alteration due to BER.

In an embodiment, the BER kinetics of polyimine polymers disclosed herein may be tuned by either temperature or moisture, or a combination of both. In an additional embodiment, the two activation mechanisms of the BER active materials have multiple-activations, which can be a beneficial property in active material research. Thus, the properties of imine-linked polymers disclosed herein result in reprocessible and recyclable functional polymers under mild conditions.

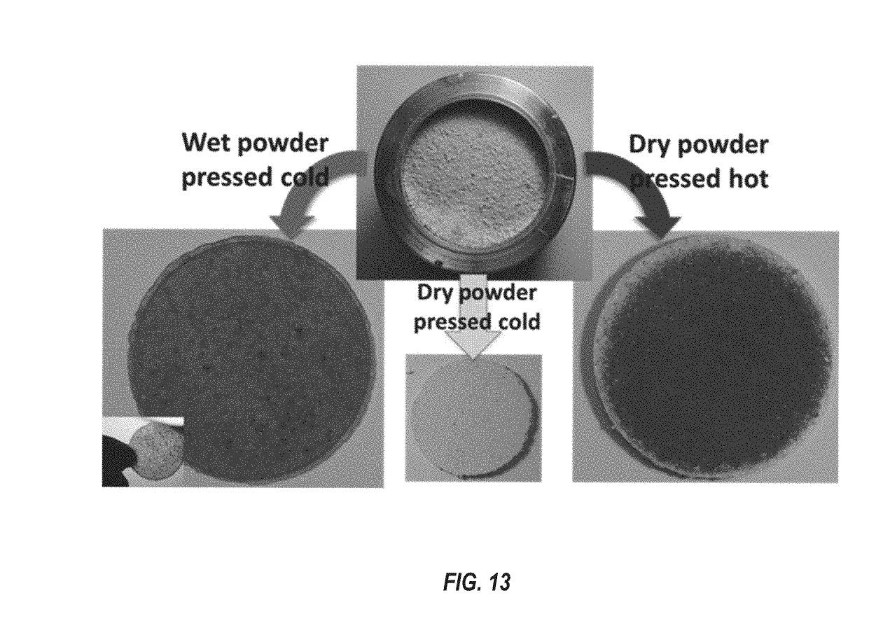

In an embodiment, water caused self-healing behavior in polyimine polymer powder that was pressed for 24 hours at room temperature and 90 kPa in an aluminum mold immersed in water. As depicted in FIG. 13, at the end of pressing time, a translucent polymer disc had been formed. After drying this disc under vacuum, and then submitting it to 105° C. for 1 hour, the mechanical strength of the water-healed polymer was tested by a stress-strain experiment. Though the resulting polymer showed typical hard polymer behavior (high elastic modulus, and relatively little elongation), its performance was inferior to that observed for the discs formed from heat-pressed powder.

As a control, a batch of dry powder was also pressed in the same mold at room temperature for 96 hours. The result was a brittle disc of compacted powder as depicted in FIG. 13. There was no macro-scale evidence of bond exchange reactions in the absence of heat or water. A similar result was obtained when wet polymer powder was simply allowed to dry without pressure. Without being bound by theory, though bond exchange reactions were likely happening within each grain of powder, there was essentially no driving force to cause the grains to merge into a coherent solid.

As depicted in FIG. 14, the processability of polyimines disclosed herein was demonstrated through causing a portion of dry polymer film to be submerged in water for 3 hours. As additionally depicted in FIG. 14, the wet, newly pliable film was then stretched over a round mold, and allowed to dry in a plastic bag containing drying agent for 24 hours. As can be seen in FIG. 14, the dry polymer film was found to retain its new shape, and could even support loads in excess of 190 g without collapsing. When the object was flattened completely by very heavy loads, it immediately sprang back to its rounded shape upon removal of the load. Thus, in an embodiment, polyimine polymers as disclosed herein can be molded into essentially any shape when wet, and by drying in that new shape, a mechanically resilient hard solid is formed.

The stress relaxation behavior of the water-saturated polymer was determined using a sample of polymer film which had been soaked in water for 24 hours, a 1% stretch stress-relaxation experiment was performed under water at 25° C. The resulting curve confirmed that the stress-relaxation behavior is comparable in water as with heating. FIG. 17 depicts the plotting of the underwater stress-relaxation experiment side-by-side with the 127.5° C. data from a time-temperature superposition (TTSP) experiment. The underwater condition was even more expedient for stress relaxation than heating the polymer to well above 100° C. Without being bound by theory, in addition to any bond exchange effect caused by the water molecules, this expedient stress relaxation could, in-part, be due to some partial hydrolysis within the network, which would allow for more freedom of movement.

Solid state ¹³C NMR spectroscopy was utilized to reveal the mechanism of water-driven self-healing in polymers of the present disclosure. Without being bound by theory, if there were a large degree of hydrolysis, the polymer could be significantly weakened while wet, and could be limited in its application in high humidity environments. In another aspect, if the polymer were not significantly hydrolyzed while wet, water could be facilitating the bond exchange reactions, and the mechanism could be similar to a heat-induced healing phenomenon.

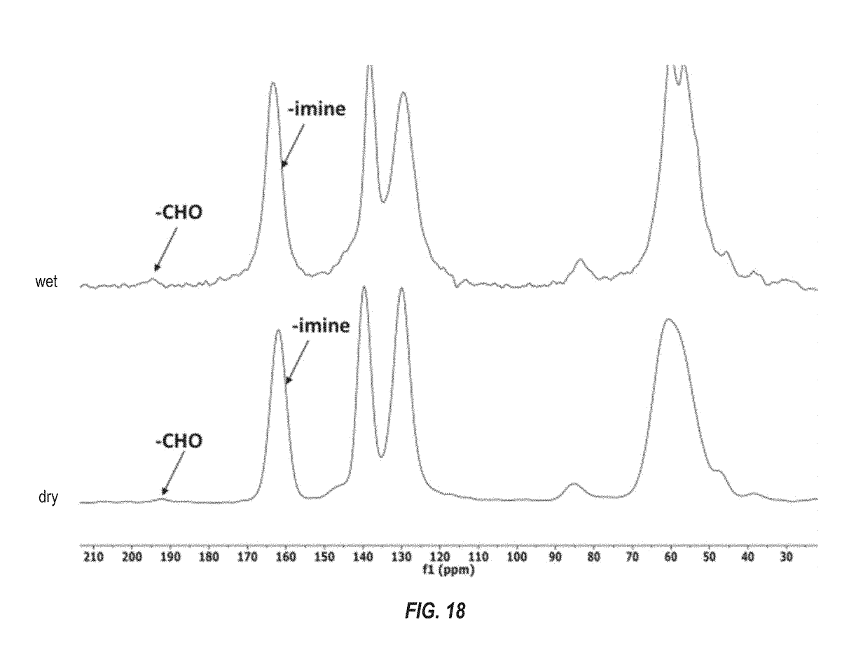

In an embodiment, hydrolysis of polyimines disclosed herein was quantified by comparing the ratios of imine bonds to aldehyde end groups in the polymer when dry to when wet. As depicted in FIG. 18, the dry polymer was found to contain an imine/aldehyde ratio of about 60/1, and the wet polymer was found to have a ratio of about 40/1. Thus, without being limited by theory, about only 1.5% of imine linkages are hydrolyzed when the polymer is immersed in water.

This means that only an insignificant number (within experimental error) of imine bonds were hydrolyzed when the polymer is immersed in water. Without being bound by theory, in addition to the small amount of hydrolysis, water may facilitate the bond exchange reactions within the polyimine polymer. This hypothesis is supported by the stress relaxation behavior of wet polymer discussed elsewhere herein. The extent of hydrolysis of the imine bonds is a matter of chemical equilibrium.

In another embodiment, the self-healing properties of polyimines could lead to solid state processing techniques for conductive polyimines In one embodiment, this could eliminate the need for alkyl side chains which are commonly added to conductive polymers to enable solution processing.

### Hydrophobicity as an “Off Switch” for Water-Induced Malleability

In certain embodiments, imine bonds derived from the reaction of aliphatic amines and aromatic aldehydes are resistant to hydrolysis. By using a very strong nucleophile (aliphatic primary amine), and a very reactive electrophile (aromatic aldehyde), the equilibrium may be shifted toward imine condensation reactions, and the relative amount of hydrolysis is minimized

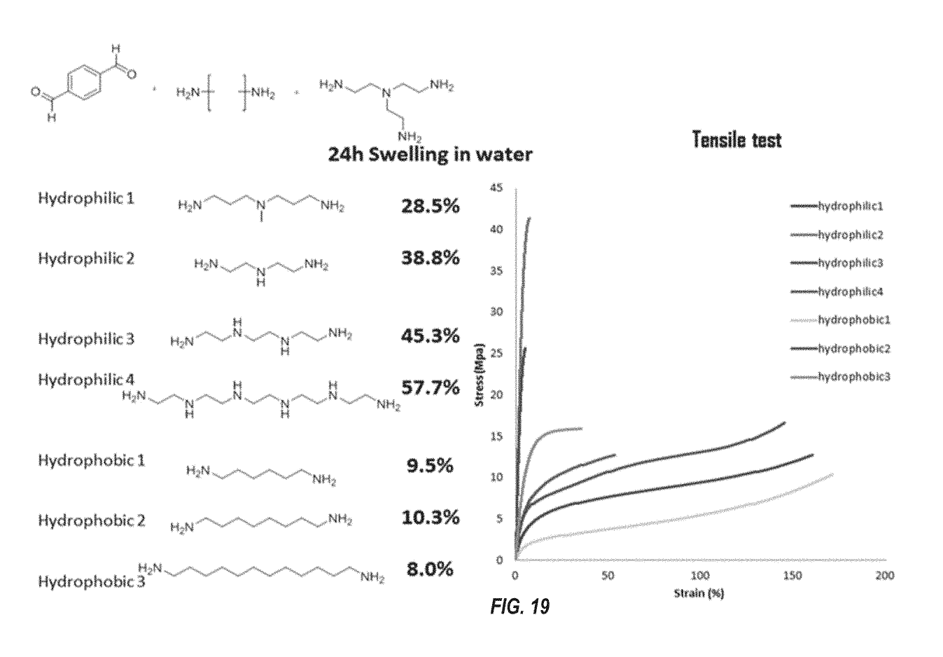

In an embodiment, polyimine polymers were synthesized using the dialdehyde and branching amines as generally depicted in Scheme 5 while using various diamine linkers. As depicted in FIG. 19, the first four diamine linkers increase in hydrophilicity going from 1 to 4 to make hydrophilic 1, hydrophilic 2, hydrophilic 3, and hydrophilic 4 polyimine polymers, respectively. Also depicted in FIG. 19, the last three diamine linkers increase in hydrophobicity going from hydrophobic 1, hydrophobic 2, and hydrophobic 3 and the resulting polyimine polymers, respectively.

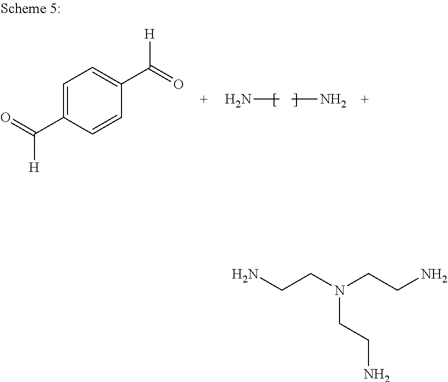

The percent swelling in water of each of hydrophilic 1-4 and hydrophobic 1-3 polymers after soaking for 24 hours is also depicted in FIG. 19. Without being bound by theory, the percent swelling roughly correlates with the hydrophilicity of the diamine linkers used to make the polyimine polymers as tested.

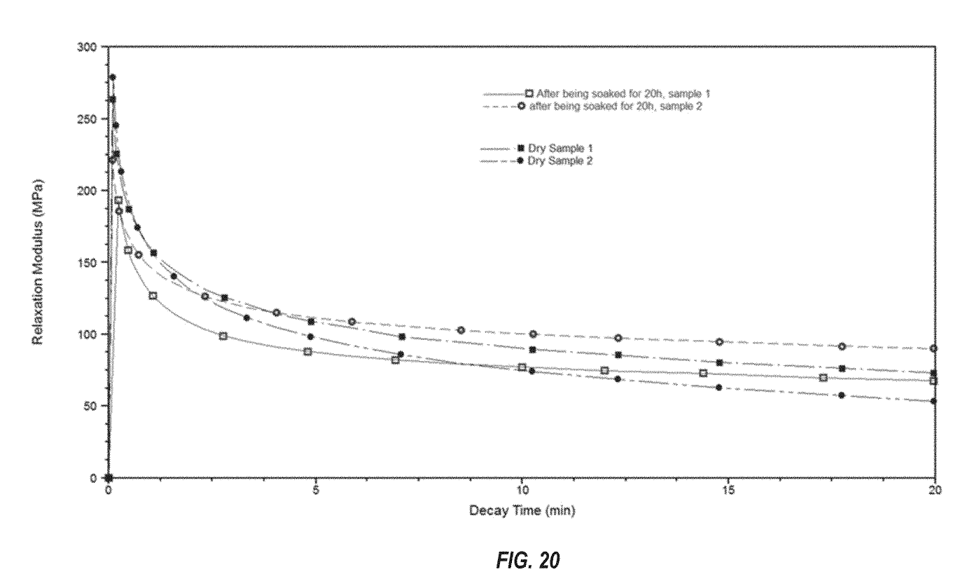

FIG. 20 depicts the stress-relaxation curves of a hydrophobic polyimine in the dry state side-by-side with a sample which had been immersed in water for 48 hours. Thus, FIG. 20 depicts a hydrophobic polyimine material which exhibits no significant response to the presence of water, it does not show significant change in its thermomechanical properties.

In an additional embodiment, applying a hydrophobic coating to a hydrophilic polyimine can provide an effective moisture barrier, resulting in environmental moisture having little to no effect on the thermomechanical behavior of a polyimine polymer.

In an embodiment, hydrophobic polyimines can be formed by using monomers with a minimum concentration of nitrogen atoms and long alkyl chains. Without being bound by theory, this may minimize the equilibrium concentration of water within the polymer matrix, and at lower concentrations there is less opportunity for water to facilitate the transamination reaction which may be a mechanism for stress-relaxation within the polyimine matrix.

### Applications

In an embodiment, polyimine polymers disclosed herein are useful as, but not limited to surface coatings, self-healing layers and as adhesives.

In an embodiment, a surface coating application of the polyimine polymers disclosed herein is a hydrophobic polyimine. Hydrophobic polyimines represent optimal moisture barrier coatings for hydrophilic polyimines with similar mechanical properties. This is because the coating is able to exchange crosslinks with the substrate through the transamination reaction. In another embodiment, hydrophobic polyimines can be used as an anti-fouling coating for metals due to the known anti-fouling character of the imine bond, combined with a robust cross-linked covalent network.

In an embodiment, polyimines made by using a diamine monomer such as hydrophobic 1 as depicted in FIG. 19, have T_{g} below room temperature and also exhibit self-healing behavior at room temperature. In an embodiment, when two freshly broken surfaces of polyimines are brought together with pressure, the surfaces weld together automatically. Longer time in contact results in greater concentration of crosslinks restored at the interface. Eventually the material regains close to its original strength.

In another embodiment, adhesive polyimine polymers are disclosed that through dative bonds, dipolar interactions, and hydrogen bonding, the polyimines stick tenaciously to inorganic surfaces such as metals, glasses, and ceramics. Glassy polyimine powders can be welded to such surfaces with heat and pressure, and represent a novel crosslinked dry adhesive powder. Elastomeric polyimines, such as those made from hydrophilic 1 depicted in FIG. 3, can be welded to surfaces at room temperature when sufficient pressure is applied. Freshly cut, or freshly broken polyimine surfaces work best for adhesion to the surfaces of glasses, metals and ceramics. Thus, polyimines disclosed herein are solid-state, self-healing adhesives which are volatile organic carbons (VOC) free.

In an embodiment, polyimine polymers disclosed herein may be processed by various techniques. Without being limited by theory, because of the polyimine's ability to exchange crosslinks, processing techniques which are usually applicable only to thermoplastics may be used on the polyimines disclosed herein. These processing techniques include, but are not limited to, blow molding, powder metallurgy plus sintering, compression molding, extrusion molding, injection molding, laminating, reaction injection molding, matrix molding, rotational molding, spin casting, transfer molding, thermoforming and vacuum forming.

### Crosslinking Effects of Transition Metal Additives on Polyimine Networks

Without being bound by theory, some metal additives can serve two competing roles in a polyimine polymer by acting both as a catalyst which lowers the activation energy of the transamination reaction, and as a cross-linker as dative bonds can form between the metal center and multiple nitrogen atoms in the polymer matrix in a polyimine matrix. In an embodiment, Scandium^{III} triflate can act both as a catalyst and as a cross-linker in polyimines disclosed herein. At sufficient concentrations, the cross-linking effect can cause an increase in the glass transition temperature (T_{g}) of the polyimine, which can result in an increase in the malleable temperature, also referred to as the vitrimeric transition or Tᵥ. At low concentrations, the catalytic behavior is dominant, and results in a decrease in the Tᵥ of the polymer.

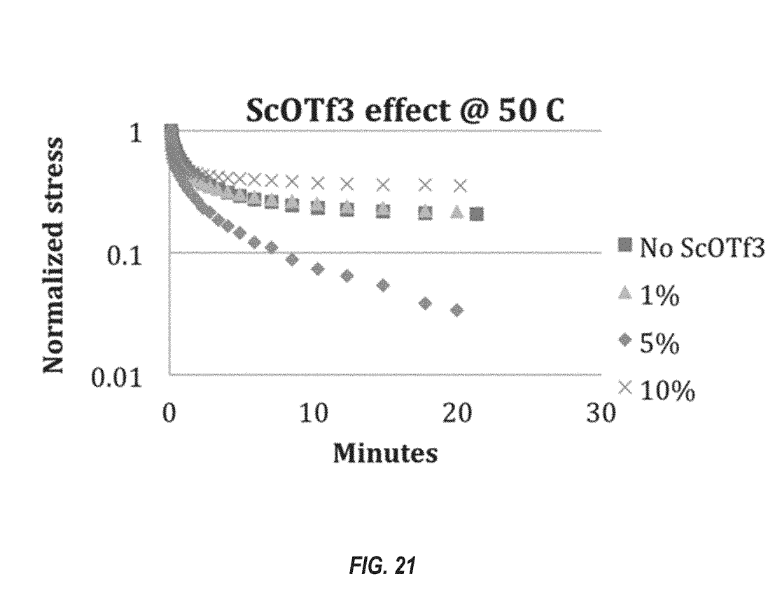

As depicted in FIG. 21, while 1% Scandium doping had no observed effect on the relaxation of the polyimine at 50° C., 5% doping resulting in a dramatic increase in relaxation rate at 50° C. (corresponding to a dramatic decrease in Tᵥ). As depicted in FIG. 21, 10% doping led to a decrease in relaxation rate (increase in Tᵥ), and is most likely due to dative bond crosslinking which could restrict thermal motion within the matrix, increasing both the T T_{g} and Tᵥ. While the catalytic effect of Lewis acids on the trans-amination reaction is well known, the cross-linking effect was not expected.

Without being bound by theory, given the nature of imine and amine nitrogens, and their high concentration within a polyimine matrix, one would suppose that metal centers with open coordination sites could act as a crosslinker, and could be used to tune the T_{g} and Tᵥ of the material.

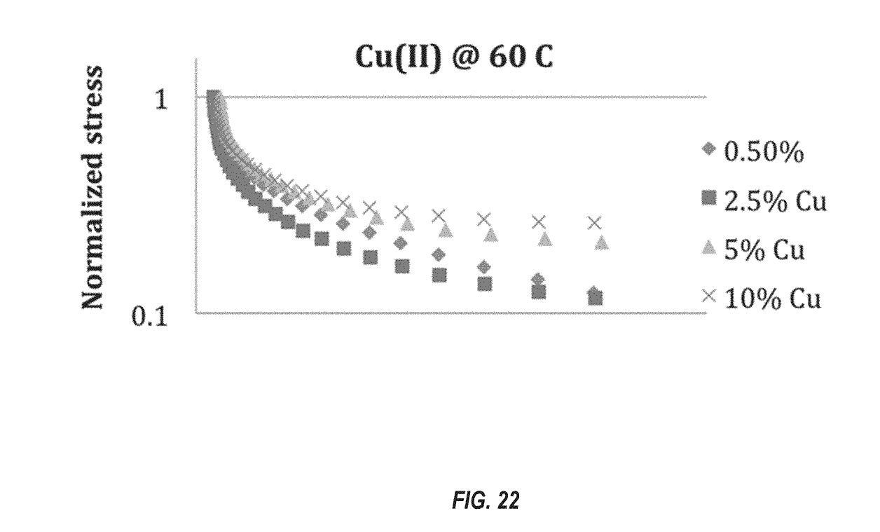

In an embodiment, as depicted in FIG. 22, a polyimine with Cu^{II} chloride added in various percentages exhibits a crosslinking effect while at the same time having negligible catalytic activity. As depicted in FIG. 22, the addition of 5% of a Cu^{II} additive can result in a significant decrease in relaxation at 60° C., corresponding to an increase in Tᵥ.

In an embodiment, the moldable transition temperature for polyimines can be tuned by either monomer choice or introduction of inorganic additives. Without being bound by theory, both approaches can be used in the process of designing a polyimine polymer formulation with desired thermal and mechanical properties.

In an embodiment, polyimines incorporating metal additives as disclosed herein exhibit a malleable temperature ranging from about 100° C. to 180° C.

### Composites

In an embodiment, network polyimines may be used as the binder/resin for advanced composite materials such as carbon fiber, fiberglass, kevlar, ultra-high molecular weight polyethylene (UHMWPE), carbon nanotubes, and common and uncommon fibrous composites. Such polyimine composites are thermomoldable, repairable and completely recyclable. In an embodiment, multilayer composite materials may be prepared by simple heat-pressing, with no wet chemical process necessary for preparing multilayered composites of any shape starting from, for example, flat sheets of polyimine film, and for example, flat sheets of (woven or non-woven) fiber and polyimine

### Single Layer Composites

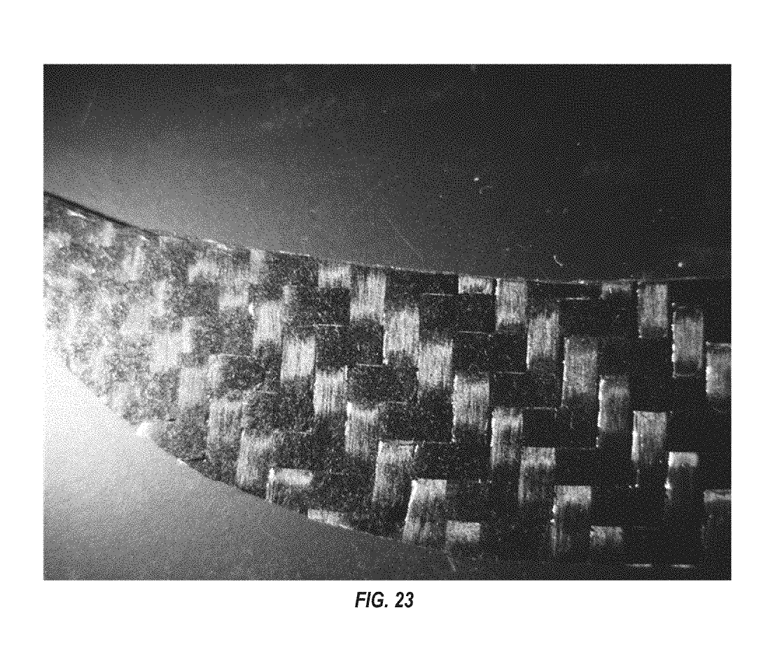

In an embodiment, 1-ply composite materials can be prepared from, for example, twill-weave carbon fiber fabric and a glassy polyimine such as hydrophilic 2 as disclosed in FIG. 23. In an embodiment, these materials can be prepared in ratios ranging from 50:50 fiber:resin by weight to 70:30 fiber:resin by weight. In another embodiment, these materials can be prepared in ratios ranging from 30:70 fiber:resin by weight to 70:30 fiber:resin by weight. In yet another embodiment, these materials can be prepared in ratios ranging from 10:90 fiber:resin by weight to 90:10 fiber:resin by weight. In an embodiment any ratio ranging between about 1 percent to about 99 percent fiber to about 1 percent to about 99 percent resin may be used depending upon the desired properties of the composite material. In an embodiment, polyimine composite materials can be prepared by a wet chemical process involving evaporation of some carrier solvent from a container containing dissolved aldehyde and amine containing monomers and also containing woven or non-woven fibers, with subsequent heat treatment to drive water from the matrix and bring the polymerization to completion. In an embodiment, ethanol may be used as a carrier solvent. In another embodiment, polyimine composite materials may be prepared via roll-to-roll processing incorporating, for example, extrusion of polyimine film, compression molding or hot calendaring of polyimine films, powders, beads, or gels. FIG. 23 is an image that depicts a 1-ply polyimine composite material made by using methods and polyimine polymers disclosed herein.

In another embodiment, diamine monomers may be used to dissolve portions of a polyimine resin to repair a damaged area of a composite device.

### Thermoforming 1-Ply Composites

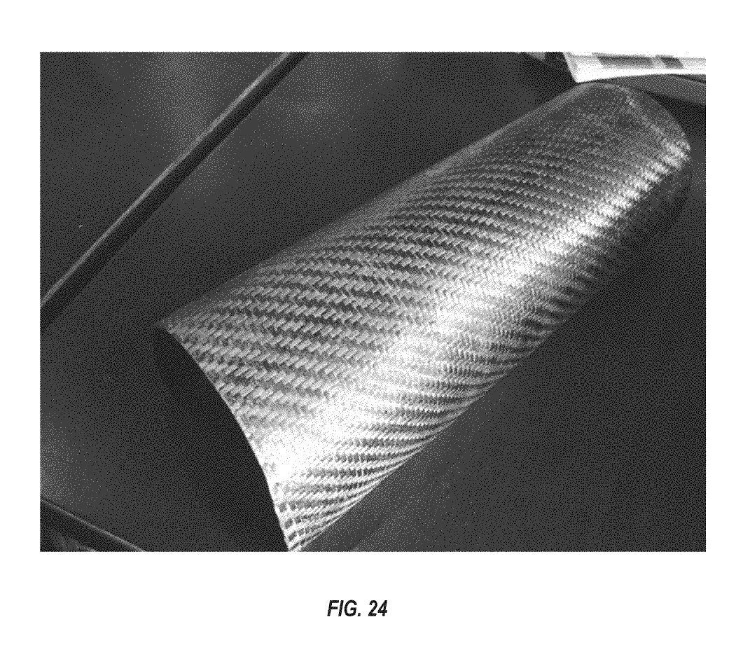

Without being limited by theory, due to novel bond-exchange reactions within the polyimine matrix, and the resulting malleability of the covalent network polyimine, the 1-ply composites disclosed herein are thermoformable when heated above the Tᵥ of the polyimine polymer resin. Thus, the material can be thermoformed repeatedly into any number of different shapes. It need only be reheated, reshaped, and held in new shape until cooled. FIG. 24 is an image that depicts a 1-ply composite which was originally a flat sheet, but was thermomolded into a curved shape.

### Multi-Layer Composites

In an embodiment, multiple 1-ply composite sheets may be combined into a single device by use of polyimine films as a dry adhesive layer in-between plies of composite. For example, a film of polyimine polymer hydrophilic 1, as depicted in FIG. 23, that has a thickness between 10 μm and 5 mm may be used as an adhesive layer and a two ply composite device may be prepared by heat pressing two 1-ply polyimine composites with a sheet of dry adhesive in-between. In one embodiment, heat and pressure may be applied to allow malleability and flow of the adhesive layer to form intimate bonding to the surfaces of both plies. In another embodiment, heat and pressure may be applied to allow malleability of the resin in the composite as well as the polyimine adhesive to promote inter-crosslinking of the adhesive with the composite on either side.

In another embodiment, multilayer devices of more than two plies may be prepared by adding one additional layer of adhesive, and one additional layer of 1-ply composite for each additional layer desired. In another embodiment, an adhesive sheet may be combined with 1-ply composite, and some substrate which requires protection, such as a layer composed of a glass, metal, ceramic, polymer, or other composite. In an embodiment, additional and subsequent layers are added in the same manner

Composite Materials with 3D Curvature

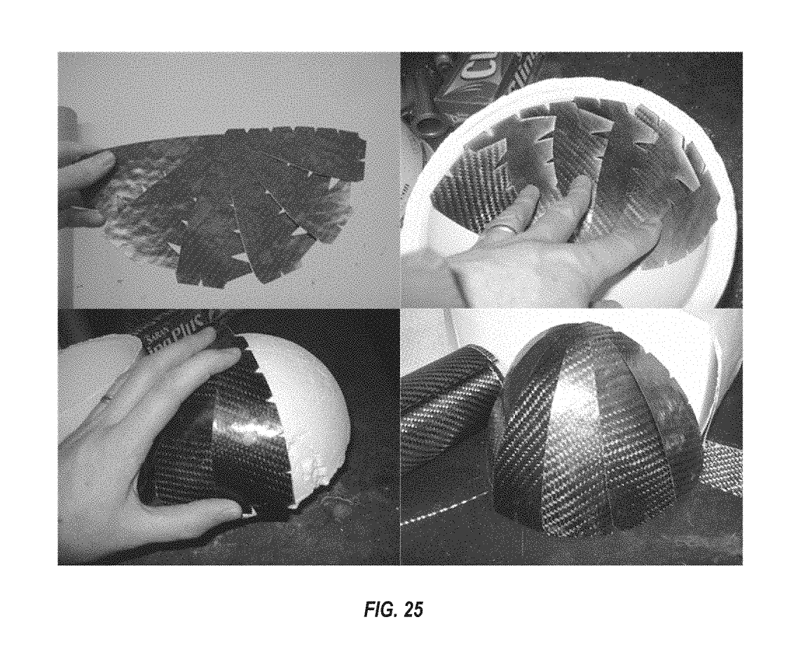

Since fibers used in advanced composites are flexible, but not stretchable, it is typically impossible to form three dimensional curvature from pre-formed flat composite sheets. Typically, a wet lay-up process of the resin is done after the woven or non-woven fibers are layed into a 3D shape or mold. However, in an embodiment, a flat sheet of 1-ply polyimine composite may be formed into any 3D shape by cutting slits in the material in strategic locations, and by removing certain areas or cutting out a pattern. In an embodiment, the cut and modified flat sheet may subsequently be thermoformed into any 3D shape, including curved shapes, such that there is an overlaping region in the final 3D shape. Thus, in an embodiment, 3D shaped polyimine composites can be created that do not contain any overlapping regions that might crosslink exchange between the resin of the surface portion, and the resin of the overlapping portion. In an embodiment, 3D shaped polyimine composites can be created that allow for crosslinks between the surface portion and an overlapping portion, and may be exchanged with an adhesive layer composed of a section of adhesive polyimine film. When properly crosslinked, the overlapping regions significantly strengthen and improve the structural integrity of the resulting thermoformed shape. In an embodiment, a flat rectangular 1-ply polyimine composite may be thermomolded into a rounded shape by thermomolding after strategic slits are cut in the material, as depicted in FIG. 25.

In another embodiment, multilayer 3D polyimine composites may be formed by thermomolding layer-by-layer by using the same approach described above, and finally heat pressing all of the thermo-formed layers together to create a final multilayered polyimine composite form.

### Recycling of Composites

In an embodiment, polyimine composites can be recycled in an efficient closed-loop process where all products of the recycling process can be reused for their original purpose with no observed loss in performance of subsequently generated polyimine composites. In an embodiment, a hydrophilic 2 polyimine, as depicted in FIG. 19, was used as the resin, then diethylene triamine (DETA) liquid was used to depolymerize the polyimine, leaving clean, unharmed carbon fiber fabric behind. The mechanism of the depolymerization is competitive transamination of the DETA solvent with the primary amine moieties within the polymer network that results in introduction of end groups, a decrease of molecular weight and solubilization of polyimine oligomers. Thus, the depolymerization mechanism is identical to the transamination reaction which enables the malleability of the polyimine network. In an embodiment, the DETA polyimine solution may directly be used to form more hydrophilic 2 polyimine by simply formulating in terephthaldehyde and tris(2-aminoethyl)amine necessary to achieve the desired stoichiometric balance of the resulting polyimine. The DETA polyimine solution may be used to form another 1-ply composite with fresh or recycled fiber material.

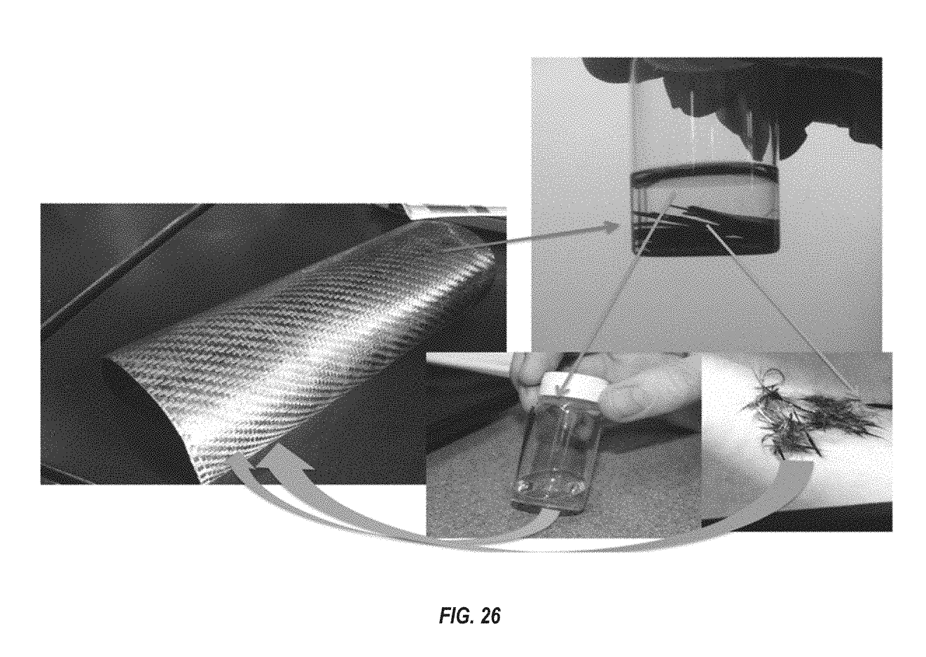

In another embodiment, the recycled DETA polyimine solution may be used in some other formulation to form a different polyimine, or other imine-containing polymer. FIG. 26 is a series of images that depicts steps of the closed-loop composite recycling process.

### Malleable Orthotics

The superior processability of polyimines and polyimine composites disclosed herein allow for the manufacture of remoldable and tough composite materials used for sheet stock material. In an embodiment, polyimine composite sheet stock material can readily intergrate into currently used vacuum-molding and other processes for the preparation of custom orthotics.

In an embodiment, polyimine polymers disclosed herein exhibit a Young's modulus of 1.8 GPa, and a tensile strength of 58 MPa, yet becomes appreciably malleable at approximately 80° C. due to BER, and not a melting transition. Thus polyimine polymers disclosed herein compare very favorably against traditional thermoplastics such as polypropylene, which has a modulus of 1.4 GPa, and tensile strength of 36 MPa, but has a melting point near 170° C. Thus, in an embodiment, polyimine materials as disclosed herein are 61% stronger and 28% stiffer (higher modulus) than polypropylene, yet can be molded at a temperature that is 90° C. lower than the melting point of polypropylene. Additionally, as disclosed herein, malleable temperatures of polyimine polymers can be tuned by monomer choice and/or the use of additives.

In an embodiment, and without being bound by theory, the low temperature molding of the non-impregnated polyimine resins as disclosed herein (virgin polymer) will enable high temperature moldability of the composite (as carbon fibers greatly increase the malleable temperature of the composite as compared to the virgin polymer material).

In an embodiment, compositions of and methods for making an advanced composite material which enables layer-by-layer vacuum molding of a polyimine composite with no curing step, and no VOC are disclosed. In an embodiment, by using methods of designing the properties of polyimine polymers disclosed herein, the material will not change shape under the extremes of normal operating conditions, for example 130 ° F. for 8 hrs, simulating the inside of a car on a hot summer day.

### Composite Formulations

In a prophetic example, for each of the polyimine polymer formulations, composite materials will be prepared using carbon fiber of various forms (twill weave, square weave, nonwoven linear, & nonwoven random). The polyimine binder-to-filler ratio will be varied from 1:9 to 9:1 for each formulation and the resulting materials' moldability and mechanical properties can be characterized.

In a prophetic example, a method will be devised for combining the composite layers under normal molding conditions. If necessary, a lower molding temperature formulation will be coated on the surface of a material to ensure the integrity of the multi-layer devices.

In a prophetic example, completed devices will be tested for fatigue/hysteresis over tens of thousands of repeated stresses (such as simulating walking), and moldability/durability. Additionally, samples of the final formulation including any additional coating can be submitted to testing in fulfillment of ISO 10993 including cytotoxicity, skin irritation, and sensitization.

In an embodiment, polyimine polymers useful for making fiber composites can be made using the following component parts:

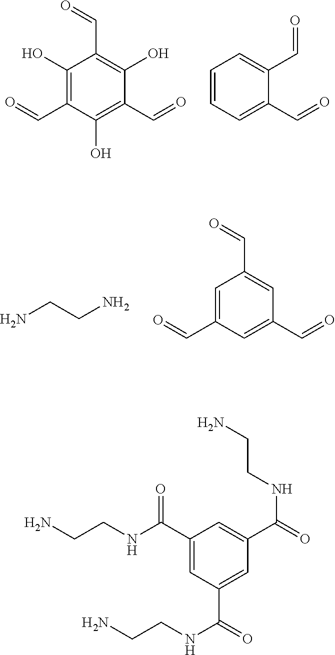

### Kits

The material properties of polyimine polymers as disclosed herein represent an ideal system for do-it-yourself prototyping of cross-linked polymeric solids. Using only heat or water and simple molds, strong polymeric structures of any shape can be easily built anywhere. This could have implications for on-demand parts manufacture, and represents an inexpensive small scale object production technology which may be complementary to 3D printing manufacturing. The recyclability of this material means that any object formed retains intrinsic value, as the material can easily be reprocessed by grinding to powder.

The disclosures of each and every patent, patent application, and publication cited herein are hereby incorporated herein by reference in their entirety.

The following examples further illustrate aspects of the present disclosure. However, they are in no way a limitation of the teachings or disclosure of the present disclosure as set forth herein.

### EXAMPLES

The disclosure is now described with reference to the following Examples. These Examples are provided for the purpose of illustration only, and the disclosure is not limited to these Examples, but rather encompasses all variations that are evident as a result of the teachings provided herein.

### Polymer Measurements, Testing and Characterization

The polymers formed using monomers disclosed herein can be characterized by thermogravimetric analysis (TGA), differential scanning calorimetry (DSC), and dynamic mechanical analyzer (DMA). The thermodynamic equilibrium of pairs of model compounds can be correlated with the thermal stability and mechanical properties of the bulk polyimine material.

### Differential Scanning Calorimetry

DSC tests were conducted to determine the transition temperatures, including the glass transition temperature (T_{g}). Once T_{g} is determined, temperatures for stress relaxation tests will be determined. We will then use this as our starting point for choosing temperatures in the stress relaxation tests as described below. The temperatures will be chosen from about 20° C. below the transition temperature then increasing at an increment of 20° C. This will allow us to capture the full relaxation spectrum in the imine system.

In an example of DSC used to characterize polyimines disclosed herein, a DSC measurement was made on a polyimine polymer using a Mettler Toledo DSC823. DSC scan was performed from 125° C. to 25° C. at a scan rate of 5° C/min on a polyimine film sample. The inflection point in the curve as depicted in FIG. 6 was taken to be the glass transition temperature, and was observed near 56° C.

### Stress Relaxation Tests

Stress relaxation tests were conducted using a dynamic mechanical analyzer operated in its tensile testing mode. In a stress relaxation test, the sample is first placed between two fixtures, which sit inside a thermal chamber. The temperature in the thermal chamber is then increased to a specific temperature then maintained at that temperature for the rest of the test. Thirty minutes after the target temperature is reached, the sample is stretched by 1% at a very fast strain rate then held at that stretch. The variation of the force is then measured. During the holding, the holding force will decrease due to either the viscosity or BERs. The instantaneous modulus (or relaxation modulus) is defined as the instantaneous holding force divided by the sample cross-section area and the strain and will be used for the investigation of BER kinetics and energy barrier.

### Mechanical Testing

A dynamic mechanical analysis (DMA) machine (Model Q800, TA Instruments, New Castle, Del., USA) was used to carry out tension tests at room temperature (23° C. locally). All the samples were trimmed into a uniform size of 12 mm×3 mm×1.1 mm, and then stretched under a constant loading rate (2 MPa/min) until broken.

As an example, for the polymer formed under conditions disclosed herein and by combining the equivalents as depicted in ratios in Scheme 6, the elastic modulus was about 1 GPa, stress at break with about 40 MPa, elongation at break between 4 and 7%.

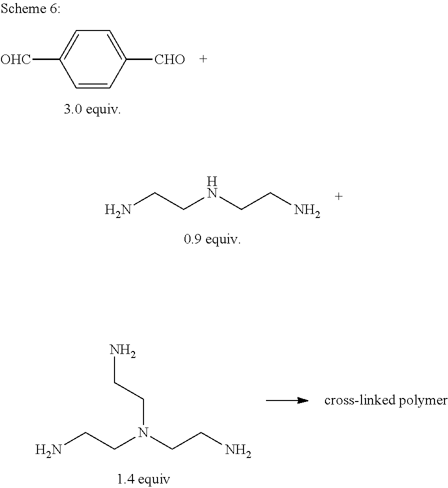 [SMILES: O=Cc1ccc(C=O)cc1 ; NCCNCCN ; NCCN(CCN)CCN]

### IR Spectra of Polyimines

Polyimine polymer samples for FT-IR measurement were prepared as thin films by drop casting CH₂Cl₂ solutions of the analytes onto NaCl plates. The IR spectra were recorded on an Avatar 370. Four scans were averaged for each measurement, and the data was analyzed using Omnisec software. The terephthaldehyde linker had a distinctive C══O stretch absorption band at 1,693 cm⁻¹. In the IR spectra of the polyimine (FIG. 8), the C══O stretch absorption band was barely detectable, while a new absorption band at 1,643 cm⁻¹ had become prominent. This band corresponded to the C══N stretch of the newly formed imine bond, indicating the consumption of aldehyde groups, and the formation of imine bonds.

### Small Molecule Model Study of a Transamination Reaction

In order to directly observe the behavior of the imine exchange reaction in a non-equilibrium system, and as depicted in Scheme 2 above, compounds aa and bb were mixed in deuterated benzene, and the formation of ab was monitored by ¹H NMR spectroscopy over time at three different temperatures: 35° C., 45° C., and 60° C.

The ¹H NMR signal for the methylene groups in aa and bb appeared as singlets at 3.98 ppm and 3.87 ppm, respectively, in CDCl₃. The methylene signal of ab was a multiplet at 3.825 ppm (in C₆D₆). FIG. 9 shows the time-dependent NMR spectrum of the sample recorded at 35° C. The gradual increase of the peak at 3.825 ppm was observed, which corresponds to the methylene group of ab.

Compound aa: Ethylenediamine (100 μL, 1.497 mmol), and benzaldehyde (275 μL, 2.69 mmol) were added to a Schlenk tube containing a magnetic stirbar, CH₂Cl4₂ (15 mL) and 4 A molecular sieves. The reaction was sealed and stirred at 60° C. in an oil bath for 18 h. The reaction mixture was then allowed to cool to room temperature. The solvent was evaporated, yielding the product with a small excess of unreacted amine groups. The product's ¹H NMR data is in good agreement with previously reported literature values (Kise, et al., 1995, J. Org. Chem. 60:3980): ¹H NMR, 500 MHz (CDCl₃) δ 3.98 ppm (s, 4H), δ 7.39 ppm (m, 6H), δ 7.69 ppm (m, 4H), δ 8.29 ppm (s, 2H).

Compound bb: The compound was prepared following the similar procedure described for compound aa. Using ethylenediamine (100 μL, 1.497 mmol), 4-bromobenzaldehyde (0.4986 g, 2.69 mmol), and CH₂Cl₂ (15 mL), the product with a small excess of unreacted amine groups was obtained. The ¹H NMR data is in good agreement with previously reported literature values (Kise, et al., 1995, J. Org. Chem. 60:3980): ¹H NMR, 500 MHz (CDCl₃) δ 3.95 ppm (s, 4H), δ 7.53 ppm (dd, 8H, JF15 Hz, h=5 Hz), δ 8.21 ppm (s, 2H).

Compound ab: Compound aa (0.1206 g, 0.51 mmol), and bb (0.2 g, 0.51 mmol) were added to a 3 mL vial. Deuterated benzene (1.5 mL) was then added, and the reactants were allowed to dissolve. The vial was then heated in an oil bath at 35° C., 45° C., or 60° C. The reaction was monitored by ¹H NMR. Each sample eventually reached an equilibrium concentration of ab approximately equal to the combined concentrations of aa & bb. The formation of ab was confirmed by electrospray ionization mass spectroscopy by direct infusion on a Waters SYNAPT G2 instrument (calculated for C₁₆H₁₆N₂Br+[M+H+]: 315.1; observed: 315.1).

Solid State NMR of Polyimine Polymers when Wet and when Dry

Solid-State, Cross-Polarization Magic Angle Spinning (CPMAS), ¹³C NMR spectroscopy was performed using a Varian INOVA-400 (Agilent Technologies, Inc.) spectrometer operating at 100.63 MHz for ¹³C observation. The probe incorporates a 5 mm Magic Angle Spinning module and coil assembly designed and constructed by Revolution NMR, Inc. (Fort Collins, Colo.), capable of spinning up to 13 KHz with Zirconia rotors (also from Revolution NMR, Inc.). Spectra were acquired using cross-polarization spin-lock and decoupling Rf fields of 80.5 KHz, and TPPM (Time Proportional Phase Modulation) decoupling was applied during signal acquisition. Chemical shifts were referenced using the absolute, calibrated spectrometer configuration frequency and magnetic field offset, such that the methyl carbons of hexamethylbenzene appear at 17.3 ppm. Sample spinning frequencies from 10.5-11.5 KHz were employed with the sample oriented at the magic angle (54.736 degrees, relative to the magnetic field axis, calibrated using the ⁷⁹Br spinning sideband pattern of KBR).

To affect the uniform cross-polarization of ¹H magnetization to all ¹³C nuclei, spectra were acquired using multiple cross-polarization contact times between 500 and 1000 .mu.sec and these were summed to yield the final spectra. These optimal contact times were determined using variable contact-time experiments and were chosen to obtain uniform excitation across all carbon atoms in the molecules of the dry and hydrated samples. Spectra were the result of between 4,096 and 5,120 scans, yielding adequate signal-to-noise ratios to observe the signal from the terminal aldehyde carbons at .about.192 PPM vs. TMS.

### Hydrolytic Stability Measurements

In a prophetic example, each of many diamine monomers of varying hydrophilicity and hydrophobicity will be reacted with 2 equivalents (1 equivalent per site) benzaldehyde in D.sub.2O, and the equilibrium concentrations of imine, and aldehyde will be measured by .sup.1H-NMR spectroscopy. Similarly, dialdehyde monomers will be treated with 2 equivalents of n-octylamine in D.sub.2O and the equilibrium concentrations of imine and aldehyde will be measured. A polymer will be prepared from the most hydrolysis-stable, and least hydrolysis-stable dialdehydes and diamines respectively. Each of these polymers' stress relaxation and mechanical properties will be measured using a DMA instrument. The polymers will then be immersed in water for 24 h and the measurements repeated. Subsequently, the polymers will be dried in mild conditions (dry box at room temperature), and the measurements repeated to see if the original dry performance can be repeated or if there is permanent decomposition of the network due to hydrolysis. The initially dry polymer will be characterized by solid state .sup.13C NMR spectroscopy, and this measurement will be repeated using the wet materials. The two measurements will be compared side-by-side for each material in order to get a snapshot of the extent of hydrolysis within each material.

The pH of the model reaction solution will be varied for the monomers discussed above. The effect of pH on the imine-formation equilibrium will be measured. The dry, virgin polymers will be soaked in aqueous solutions of varying pH, and the stress-relaxation rate will be characterized as a function of pH for each of the polymers.

### Waterproofing Thermodynamically Unstable Polyimines

In another prophetic example, each of the two most hydrolysable monomers (one diamine and one dialdehyde) will be used to form a polymer with terephthaldehyde and aldehyde crosslinker, and 1,8-octadiamine and amino crosslinker, respectively. Another set of polymers will be formed from similar monomers which incorporate greasy aliphatic C₁₆H₃₃ side chains. The relative hydrophobicity of each polymer can be determined by contact angle measurements. Each polymer's mechanical and stress-relaxation properties will be measured, and then compared with similar measurements of the material after soaking in water for 24 h. Subsequently the polymers will be submersed in 95° C. water for 24 h, and the measurements repeated. Thus, the effect of hydrophobicity of the network towards hydrolysis will be characterized.

Composite Material with 3D Structure

A composite material using carbon fiber and a polyimine resin as disclosed herein, was made into a hemispherical shape. The images in FIG. 25 depict the following steps that were used to make the hemispherical shape. As depicted in FIG. 26, first, a pattern of slits is cut into a 1-ply composite sheet. Next the positive and negative molds are placed in the oven and heated above 100° C. Next the molds are removed from the oven, and the 1-ply composite sheet is placed between the molds, and left outside the oven as the molds slowly cool to room temp. This shapes the 1 ply composite. To fix the new shape, pieces of hydrophilic 1 (as disclosed herein, see at least FIG. 19) sheet stock are cut to the shape of the overlap tabs, and pressed onto the overlap tabs of the cut and shaped composite.

The molding procedure is repeated and temperature is adjusted as needed to generate a 1-ply shaped composite.

Additional layers of 1-ply composite are added by once again heating the molds, placing the shaped 1-ply composite material in the mold, and placing an additional flat sheet of cut 1-ply composite on top of the preformed “outer layer”, then by placing the positive mold on top of the flat sheet to allow the inner layer to be molded to fit inside the outer layer. After the molds are cool, remove the inner layer sheet which should now be shaped but not bonded at the tabs or bonded to the outer layer. A sheet of hydrophilic 1 is cut into an identical pattern but the overlap tabs are removed and placed onto the tab-portions of the inner-layer sheet. The outer layer is removed from the mold and the mold is heated. The mold is removed from the oven, and the outer layer is placed in the negative mold followed by the sheet of hydrophilic 1, followed by the inner layer composite sheet, and finally the positive mold is pressed using the appropriate amount of pressure to shape the sheet of hydrophilic 1. When cool, the 2 layer formed composite object is complete. For additional layers, his procedure is repeated.

In an embodiment of the process to make composite materials with 3D structure, all the layers, as described above, can be combined and heat pressed in a single event.

### Electrolyte Membrane Facilitated by a Self-Healing Polymer Matrix

Emergent technologies are driving iterations of the lithium-ion battery to exhibit enhanced safety and higher temperature capabilities. The commercial lithium-ion battery has remained relatively unchanged since its inception in 1991. As such, it would be challenging to adopt the current liquid electrolyte system (LiPF₆ dissolved in ethylene carbonate/diethyl carbonate) due to concerns of flammability. Batteries encompassing inorganic solid electrolytes, known as solid-state batteries, have attracted significant attention in recent years due to the resolution of overheating and thermal runaway, as well as lithium-ion conductivities matching liquids yet still maintaining a lithium transference number of unity. With commercial deployment rapidly approaching, most solid-state research focuses on electrode compositions or electrolyte chemistries. Few reports emphasize the implicit challenges in the design of an all-solid-state battery, often reworking the solid system to mimic processing of a liquid-based system. However, solids present vastly different mechanical and fundamental properties. Novel processes and approaches must be employed if solid electrolyte batteries are to be advanced to commercial viability. Liquid electrolyte systems have the inherent advantage of maintaining intimate contact with electrode materials. A successful solid electrolyte must likewise conform its surface to establish close contact with electrode surfaces.

There are two main classes of inorganic, solid, lithium electrolytes: oxides and sulfides. Oxide electrolytes, while maintaining stability in air, may be incompatible with standard electrode materials, require sintering at elevated temperatures, and possess high charge transfer resistances due to poor electrolyte—electrode contact. Oxide electrolytes tend to exhibit shear moduli of greater than 50 GPa. Intimate contact with battery materials is therefore precluded due to the lack of plastic deformation under stress.

On the other hand, the sulfide family of solid electrolytes, such as Li₁₀MP₂S₁₂ crystals and Li₂S—P₂5₅ glass ceramics, have lithium-ion conductivities comparable to liquid electrolytes, may be simply processed by cold-compacting the powders, and exhibit ductile-like mechanical properties. Thus, the present study utilizes the sulfide family of solid electrolytes, namely 77.5Li₂S-22.5P₂S₅ (denoted as a77.5).

Assembly of laboratory bulk solid-state cells occurs by applying high pressures to the powder forms of the cathode, electrolyte, and anode thus forming a trilayer pellet. Due to the brittle nature of the materials being used, if the separator layer is less than ≈1 mm, cracking tends to develop through the pellet, rendering the cell useless. Heretofore, limited research has focused on reducing this layer thickness while maintaining a bulk configuration (non-thin-film battery). Pulsed laser deposition (PLD) and chemical vapor deposition (CVD) have been used to deposit thin solid films demonstrating good cycling performance High vacuum deposition techniques, however, are extremely expensive and do not provide a scalable process for commercial development of the solid-state battery.

Previous attempts have been made to apply a polymeric binder to the inorganic solid. However, such attempts resulted in coating electrolyte particles in the polymer, thus impeding interparticle contact, and requiring a substrate to coat on negating free-standing applications. Such attempts also failed to allow absolute density, which hinders electrode performance Therefore, an optimal method of processing a solid-state battery would encompass a cheap, scalable process, one that does not impede the conduction capabilities, and one in which the materials used are mechanically pliant to suppress cracking.

### Experimental Results

The following disclosure provides a new method of developing a solid electrolytein-polymer matrix (SEPM) to form the electrolyte layer. This method takes advantage of the fact that the solid electrolyte pellet is about 15% porous in the green body state. By filling empty voids with an organic polymer, we create a crosslinked polymer matrix in situ to provide mechanical robustness while preserving lithium-ion transport pathways in between solid electrolyte particles. Using a newly derived malleable thermoset polymer (i.e., as described herein above) paired with an Li₂S—P₂S₅ inorganic electrolyte produces a stand-alone membrane of 64 μm in thickness, high inorganic material loading (80%), and near theoretical density. The membrane performs on par with traditionally prepared solid-state batteries yet has increased the gravimetric and volumetric cell energy densities by an order of magnitude.

The processing of the SEPM is completely dry, representing not only a new method of processing for batteries, but a technique to form other composites such as high mass-loading mixed matrix membranes. Membranes based on the traditional thermoplastic polymers suffer from active material agglomeration and sedimentation. Additionally, the melt-flow behavior of thermoplastic polymers leads to highly resistive surface coatings that inhibit interparticle conductive contact. Thermoset materials, which must be cured in situ, exhibit the same drawbacks as thermoplastic polymers.

Recent advances in polymer chemistry have led to the development of malleable covalent network polymers, often called vitrimers. Vitrimers are capable of stress relaxation and flow due to dynamic covalent bonding of reversible crosslinks within the network. Network polyimines were used in this study: they are simple to prepare (one step from commercially available monomers), and contain no metal catalysts, which could demonstrate undesired redox activity.

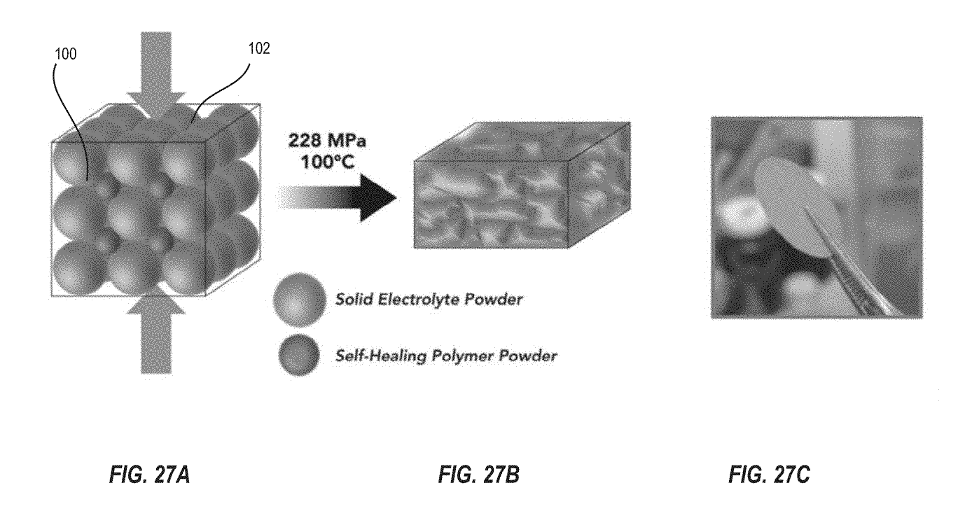

FIGS. 27A and 27B represent the SEPM concept. Starting in a bulk powder form, and taking advantage of the malleable properties of the polyimine/self-healing polymer, application of a hot isostatic press will theoretically form a continuous cross-linked network of the polyimine (represented as particles 100) interspersed between the voids of the glass-ceramic solid electrolyte (represented as particles 102). The malleability of polyimines allows for material flow to increase the density of the composite, and instill mechanical toughness, with a minimal impact on the ionic conductivity of the electrolyte. This process does not preclude interparticle contact of the solid electrolyte particles as only a few domains of polymer are introduced. This stands in stark contrast to polymeric binders used in solution processes. These act to coat all surfaces of each individual solid electrolyte particle.

FIG. 27C represents an image of a prepared SEPM membrane ≈100 μm in thickness with 80% massloading solid electrolyte. In this work, variations of the polyimine were developed by replacing the monomer diethlyene triamine with pentaethylene hexamine or 3,3′-diaminodipropyl-N-methylamine

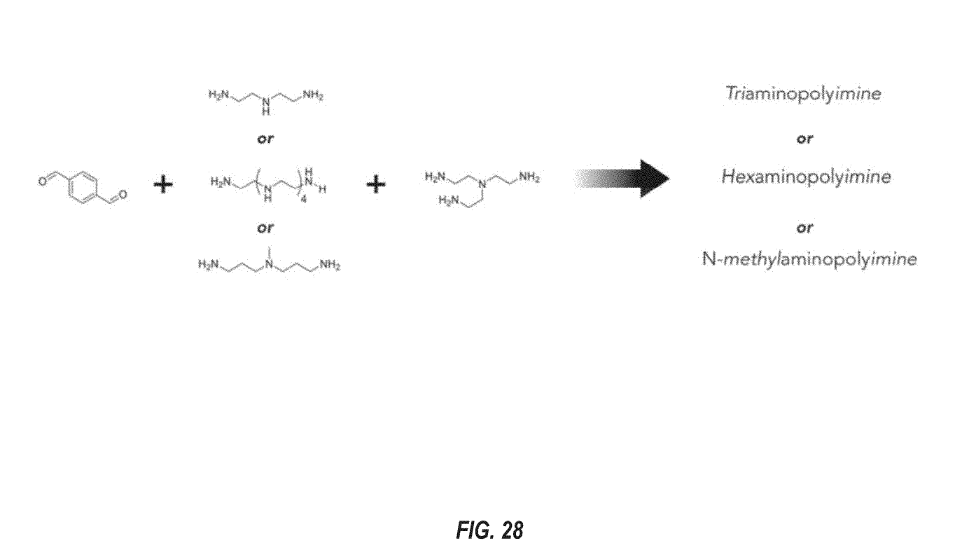

The structures of the monomers are given in FIG. 28 along with nomenclature used for the rest of this disclosure: tri-imine, hexa-imine, and methyl-imine Increased elasticity is achieved by either creating a more open framework (hexa-imine) or reducing the degree of hydrogen bonding (methyl-imine).

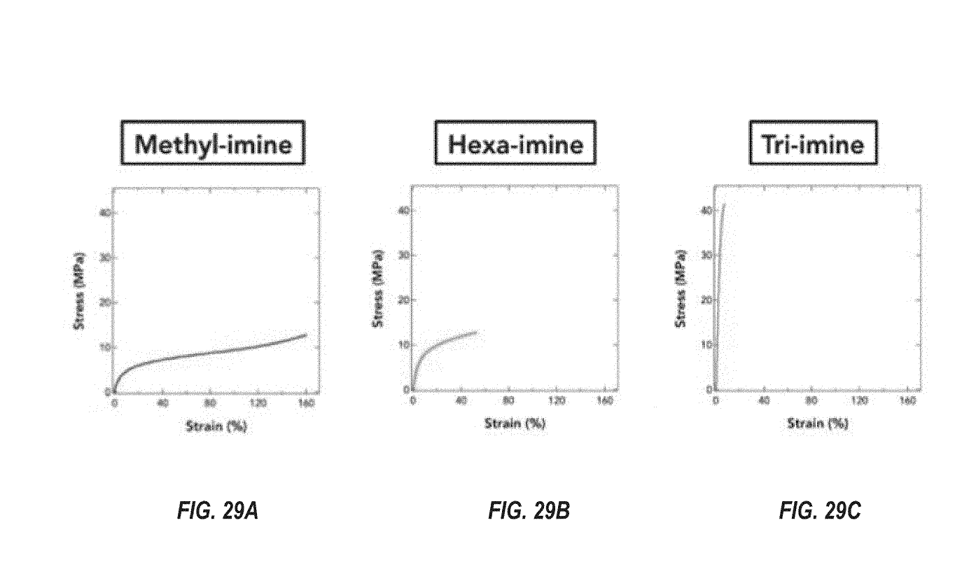

FIGS. 29A-I present tensile test results for the new polymers, temperature-dependent stress relaxation, and bond exchange energy. All three formulations exhibit malleable character but hexa-imine and methyl-imine achieved this characteristic at lower temperatures relating to their reduced glass transition temperature.

FIGS. 29A, 29B and 29C are room temperature stress-strain curves of methyl-imine, hexa-imine and tri-imine, respectively, illustrating mechanical performance, as well as temperature-dependent stress-relaxation of 3 formulations of network polyimine The polymers were prepared by mixing the ethanolic solutions of the monomers in molar ratios of 1:0.45:0.367 (terephthaldehyde to diamino linker to tris(2-aminoethyl)amine) The mixture was added to a tray of silicone-coated paper, and the ethanol was allowed to evaporate. After curing the films in a heat press (1 hr 100 ° C.), the solid polymers were ground to powder using sand paper. The self-healing behavior of the methyl-imine formulation is due to its room temperature malleability, and the powders and films of this formulation are observed to heal into coherent solids when left under gentle pressures at room temperature <<Question—what does “gentle pressure” mean?>>.

DMA Tension test:

A dynamic mechanical analysis (DMA) machine (Model Q800, TA Instruments, New Castle, Del., USA) was used to carry out tension tests at room temperature (23 ° C. locally). All samples were trimmed into a uniform size of 12 mm×3 mm×1 1 mm, and then stretched under a constant loading rate (2 MPa min-1) until broken.

### DMA Stress Relaxation:

The time and temperature dependent relaxation modulus of the polyimine thermoset was also tested on the DMA machine (Model Q800, TA Instruments, New Castle, Del., USA). During the test, a polymer sample with the same dimension mentioned above was initially preloaded by 1×10-3 N force to maintain straightness. After reaching the testing temperature, it was allowed 30 min to reach thermal equilibrium. The specimen was stretched by 1% on the DMA machine and the deformation was maintained throughout the test. The decrease of stress was recorded and the stress relaxation modulus was calculated. FIGS. 29D-29F depict the results of relaxation tests for the methyl-imine, hexa-imine and tri-imine, respectively, at 5 different temperatures between 50 ° C. and 90 ° C. on a double logarithmic plot. Then selecting 40 ° C. as a reference temperature (Tr), each modulus curve in FIGS. 29D-29F is shifted horizontally to overlap with the next. This produces the master relaxation curve, which spans many decades of modulus and represents the actual relaxation behavior of the polymer within a long timescale 40 ° C. The corresponding shift factors are plotted against temperature in FIGS. 29G-29I (again, for the methyl-imine, hexa-imine and tri-imine, respectively).

The master relaxation curve suggests that the kinetics of the BER induced stress relaxation follows the well-known temperature-time superposition (TTSP) principles. To quantitatively study the relaxation behavior, we used the following definition of relaxation modulus:

$$t = \frac{1}{K} exp ( \frac{Ea}{RT} ) \qquad Equation 3$$

where k is a kinetic coe□cient (k>0) R is the gas constant with R=8.31446 J K⁻¹ mol⁻¹, and Eₐ is the activation energy.

The shift factor, namely the ratio between the temperature dependent relaxation time and the relaxation time at a reference temperature Tᵣ, is therefore expressed as:

$$∝ = exp [ \frac{Ea}{RT} ( \frac{!}{T} - \frac{1}{{T}_{r}} ) ] \qquad Equation 4$$

The predicted shift factors of the relaxation curves are also plotted in FIGS. 29G-29I to compare with the experimental data. An Arrhenius-type dependence on temperature is revealed, which is consistent with what was previously reported for the tri-imine By further examination of Equation 4 we found that in the semi-log scale, the energy barrier could be determined by the slope of the shift factor curve. As shown in Figures FIGS. 29G-29I, by measuring the curve slope, the energy barrier Eₐ is calculated for each formulation.

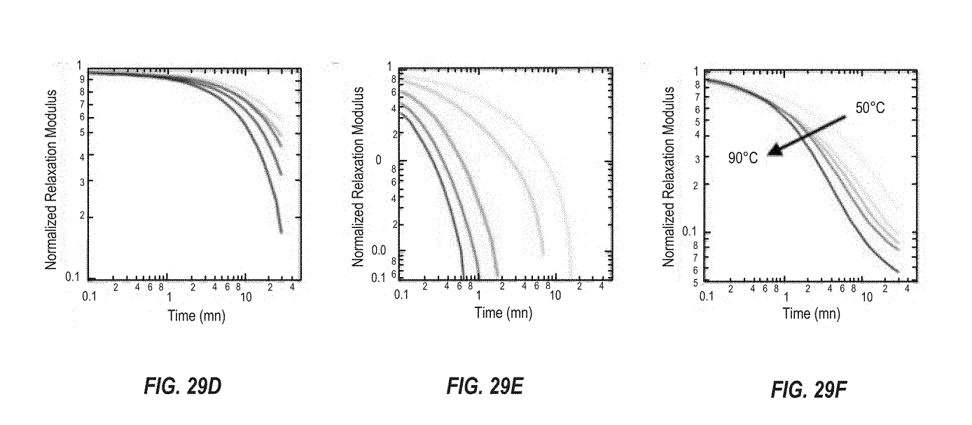

To compare membrane properties, all the formulations as well as pure solid electrolyte were prepared into pellets ≈1 mm thick. Table 2 presents the densities, room temperature ionic conductivity, and activation energies of the SEPMs. The measured experimental densities of the SEPMs as a function of the theoretical density are displayed in FIG. 30A.

TABLE 2

| | | | | Composite |
|---|---|---|---|---|
| | Theoretical | Composite | Composite | activation |
| | density | relative | σ 25° C. | energy |
| Material | [g cm⁻³] | density | [mS cm⁻¹] | [kJ mol⁻¹] |
| a77.5 | 1.75^{a)} | 0.85 ± 0.01 | 0.54 | 34.7 |
| Methyl-imine | 1.07 ± 0.02 | 0.97 ± 0.02 | 0.092 | 34.8 |
| Hexa-imine | 0.93 ± 0.02 | 0.94 ± 0.02 | 0.056 | 34.5 |
| Tri-imine | 1.00 ± 0.02 | 0.92 ± 0.02 | 0.015 | 33.3 |

Summary of SEPM composite membrane properties. All composites consist of 80% solid electrolyte by weight.
^{a)}Density tabulated using tie line between Li₂S and P₂S₅ theoretical densities. Value is in good agreement with the literature.

The pure a77.5 pellet measures a relative density of 0.85 or about 15% porous. The most elastomeric polyimine, methyl-imine, forms an SEPM with a relative density of about 0.97. This is an excellent result as full density improves solid electrolyte contact. Although addition of the polyimine does reduce overall conductivity, methyl-imine SEPM achieves a room temperature conductivity of ≈1×10⁻⁴ S cm⁻¹ . This is on the same order of magnitude as the bulk electrolyte.

It is important to determine if there is any impact of the polyimine on conductive abilities of a77.5; this can be seen in the Arrhenius plots for the SEPMs (FIG. 30B). It is clear that for each polyimine, no change in activation energy occurs. Activation energy is a fundamental material property for ionic motion that defines the energy barrier to ion hopping, and it can therefore be concluded that any decrease in conductivity from a pure a77.5 separator by the addition of polyimine is simply due to the inclusion of resistive domains. This is supported by the trend of decreasing ionic conductivity with decreasing elasticity of the polyimine, i.e., larger domain sizes.

An overarching goal is to achieve a membrane with thickness less than about 100 μm with a greater conductance than a pure a77.5 separator. The methyl-imine SEPM was pursued due to its high bulk conductivity. The thickness of the methyl-imine SEPM is reduced and its conductance value is measured rather than conductivity, and is therefore more reflective of battery performance The mass loading of the separator was normalized to area to account for any variations in thickness between the samples. Results are displayed in FIG. 30C, which shows that the methyl-imine-based SEPM achieves a conductance greater than a pure a77.5 separator at a mass loading of 7.5 mg cm⁻², which corresponds to a thickness of 63.7 μm. It should be noted that although these SEPMs were processed at elevated temperature, these same structures could also be formed at room temperature, as methyl-imine demonstrates malleable properties at ambient conditions. However, in order to speed up this process, increased temperature was applied. A clear inverse trend is evident meaning a linear resistance decrease is present with decreasing SEPM thickness. At a mass loading of 7.5 mg cm⁻², the SEPM achieves a greater conductance than a pure solid electrolyte membrane. This may be extrapolated for any solid electrolyte used, so that one should always be able to achieve a greater conductance than the solid electrolyte counterpart at this thickness level.

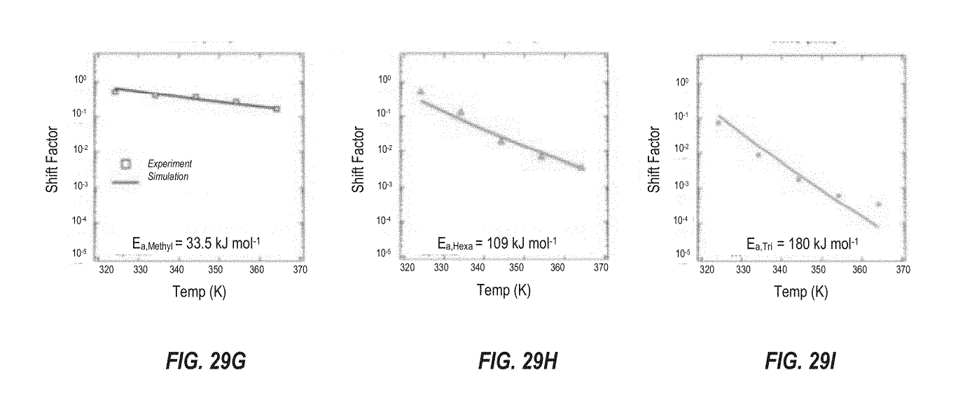

Increased amount of error occurred at the thinner levels due to variations in the Ag-blocking electrode areas. To confirm the hypothesized structure of self-healing polymer dispersed throughout a densified solid electrolyte, scanning electron microscopy (SEM) was used to image the top and cross-sectioned view of the 7.5 mg cm⁻² methyl-imine SEPM, as shown in FIG. 31A and FIG. 31C, respectively. Methyl-imine is observed to be well dispersed with domain sizes on the order of a few micrometers. FIG. 31B is an enhanced view of the interface between polyimine and a77.5. The interface appears to be continuous, demonstrating the ability of the methyl-imine to flow through the electrolyte pore space. This confirms the idealized structural mechanism of filling the voids of the solid electrolyte with polymer.

The cross-section of SEPM methyl-imine (FIG. 31C) reveals a thickness of 63.7 μm. To track dispersion and interconnectedness of polyimine, energy-dispersive X-ray spectroscopy (EDS) was used to distinguish between polyimine and a77.5. FIG. 31D, an EDS map of C—K signal, represents the polyimine, and FIGS. 31E and 31F are EDS maps of P—K and S—K respectively, representing the a77.5. It is clear that the polyimine is well dispersed and domains appear connected. Ostensibly, the bottleneck for reducing the thickness of the SEPM further is dependent on the following polyimine parameters: flow, particle size, and distribution within composite. Further work will be focused on using a lower crosslinked density polyimine and exploring techniques such as cryogenic ball milling.

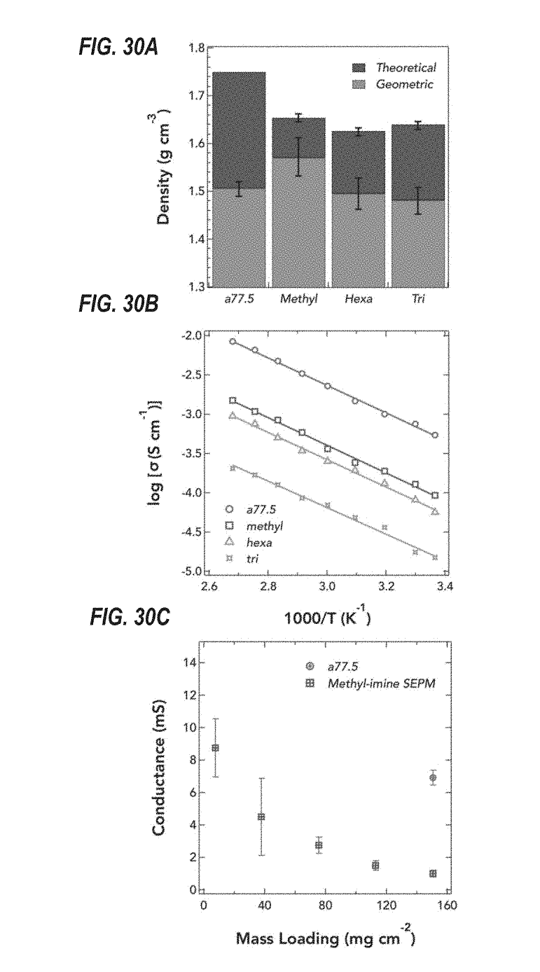

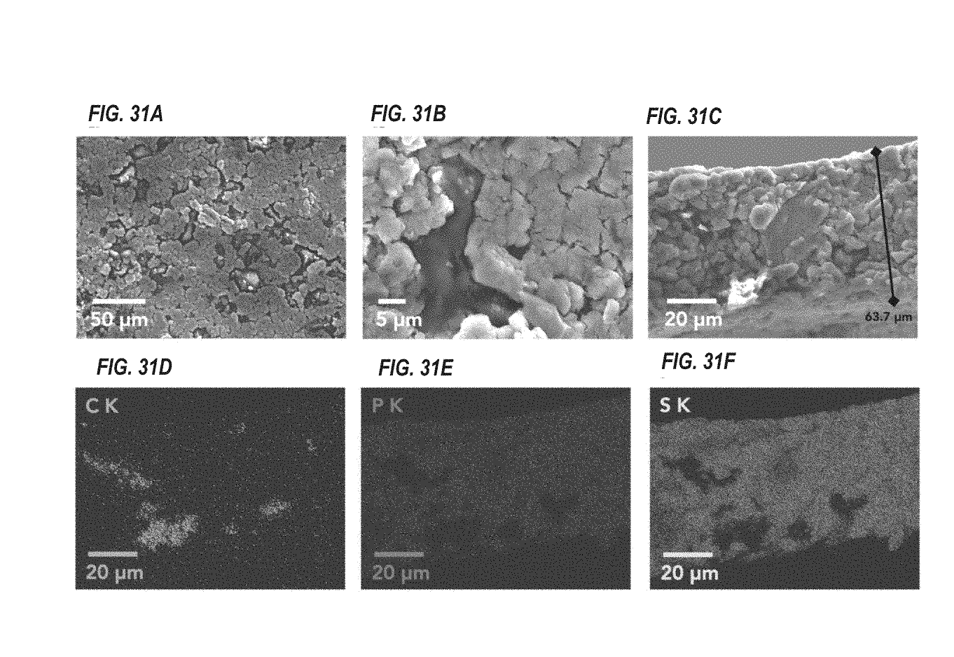

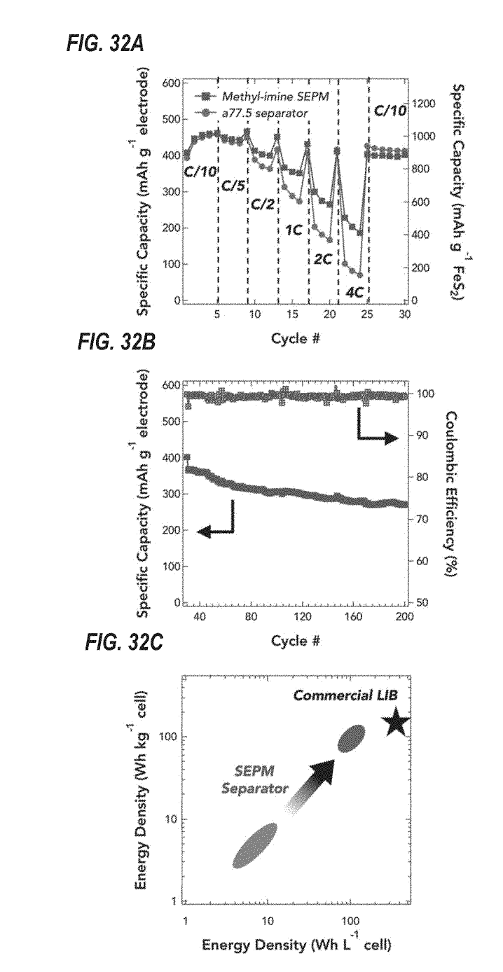

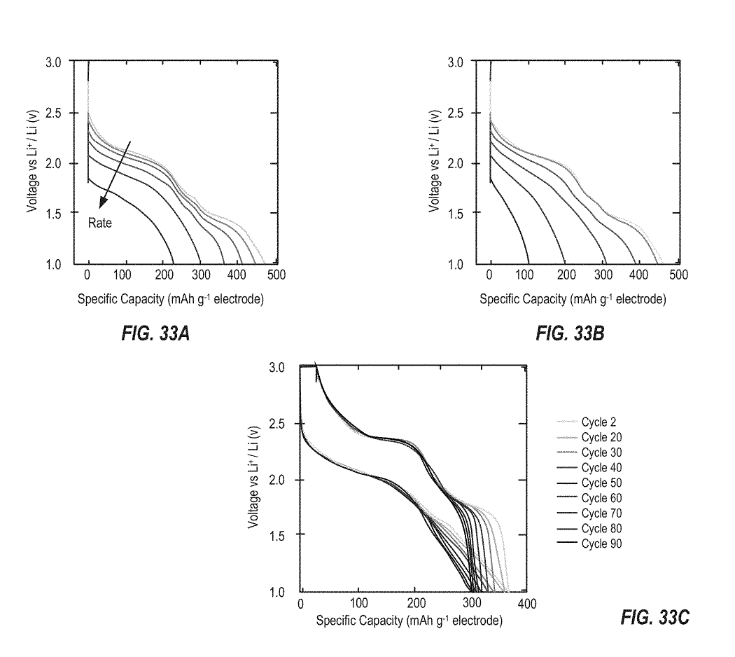

To demonstrate its application, the methyl-imine SEPM was investigated as a functional separator in an all solid-state lithium-ion battery. A cathode containing 45% weight FeS₂ was mounted on an SEPM of mass loading 7.5 mg cm⁻² using uniaxial compression. FIG. 32A displays a symmetric rate study comparing discharge performance of the SEPM cell to a standard a77.5 construction. Associated voltage profiles are shown in FIGS. 33A-C. FIG. 33A and FIG. 33B are the discharge profiles of the methyl-imine SEPM and a77.5 separator cells, respectively. As shown, the main difference between the two cells is the larger ohmic overpotential associated with the a77.5 separator leading to lower capacity. FIG. 33C illustrates the evolution of voltage profiles for the methyl-imine SEPM cell run at C/5 for extended cycling. The loss in capacity is attributed to a shortening of the lower plateau due to the slower kinetics in the conversion reaction. While capacity is lost during this period of cycling, the energy density does not degrade nearly as much as the high voltage region remains relatively intact.

Returning to FIG. 32A, at cycle 5, the cell achieves a specific capacity of around 450 mA h g⁻¹ (mass normalized with respect to the full electrode). This corresponds to an FeS₂ -specific capacity of 1000 mA h g⁻¹. Greater than theoretical capacity may be achieved through electrochemical activation of the sulfide components of the electrolyte. The SEPM shows enhanced rate capability due to the greater conductance value of the separator manifesting in a smaller ohmic overpotential. The identical capacity retention of both cells results from identical FeS₂ reaction kinetics, inherent to the cathode itself.

FIG. 32B shows long-term cycling at a rate of C/5. Over 200 cycles, the SEPM-based battery retains 74% capacity, constituting one of the longest lasting bulk FeS₂ cells reported to date. See again FIGS. 33A-33C for evolution of the voltage profile in this region.

By measuring out the cathode tap density, we report on the volumetric and gravimetric cell-based energy density values. By replacing the thick a77.5 separator with the methyl-imine SEPM, the cell level energy density values are increased by an order of magnitude and rapidly approach commercial lithium-ion battery values. FIG. 32C illustrates enhancement in gravimetric and volumetric energy densities by moving to an SEPM configuration. Additional work to improve cathode capacity may further enhance this value.

We have presented a new strategy for forming a thin electrolyte membrane by creating a solid electrolyte-in-polymer matrix. An in situ derived polymer matrix may be formed by penetrating the void space of an inorganic solid, green compact through reversible cross-links of the self-healing polymer. Essentially, a mixed matrix is formed with a high mass loading of 80% solid electrolyte by weight. This constitutes an order of magnitude improvement in thickness from a 1 mm to a 64 μm separator, achieving a greater conductance and increasing relative density to 97%. The desired structure is confirmed with SEM and EDS. The SEPM, when used as a separator in an all-solid-state battery with an FeS₂ -based cathode, achieves excellent rate capability and stable cycling for over 200 cycles. This is the first report of a self-healing material being used to create a solid membrane and first application in a solid-state battery. Processing in the dry condition may represent a paradigm shift for incorporating high active material mass loadings into mixed-matrix membranes.

### Experimental Specifics

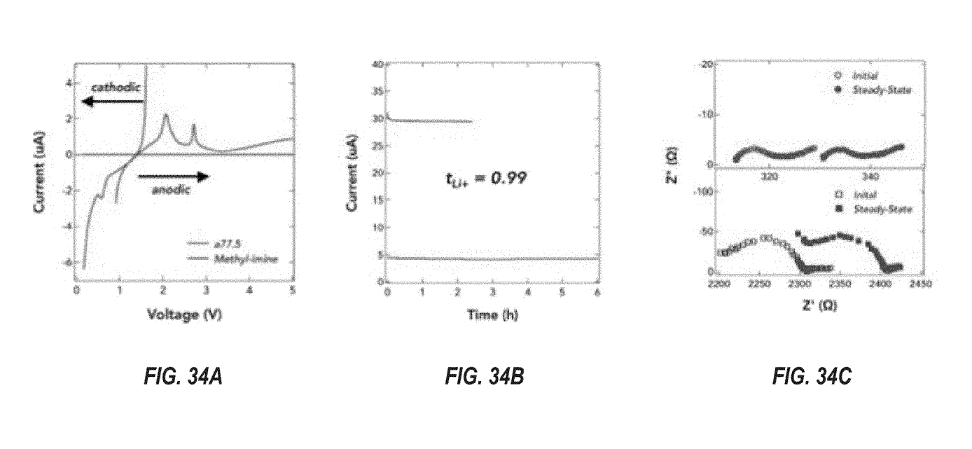

All processes and experiments detailed above were carried out in an argon environment. a77.5 and polyimine powders were measured in a 4 to 1 weight ratio into an agate jar with 50×6 mm agate balls; the powders were mixed through planetary ball milling for 30 min. Free-standing pellets (referred to as SEPM) of the resultant powder were developed with the following procedure: the composite was pressed at 38 MPa in a stainless steel dye (φ=1.3 cm) while the temperature was raised to 100° C. at 5° C. min⁻¹; the pressure was held for another 15 min before increasing pressure to 228 MPa; the composite was held at this temperature and pressure for 1 h, periodically reapplying pressure lost due to shrinkage. Densities were determined using a micrometer-resolution caliper to measure thickness (Mitutoyo, 547-400) and accurate mass of the samples. Three samples were prepared for each formulation to get a standard error. Theoretical density for a77.5 is difficult to accurately measure due to the nature of glass ceramics. 1.75 g cm⁻¹ was chosen using a tie line between densities of the precursors: Li₂S and P₂S₅. This value closely matches with previous reports for similar near full-dense variations. Theoretical densities of polyimine materials were measured by pressing polyimine powders into translucent films using the method outlined previously. For ionic conductivity tests, silver paint (SPI) was used as blocking electrodes and allowed to cure at 120° C. under ambient pressure. AC impedance measurements were taken using a Solartron 1260 with a 100 mV amplitude between 1 MHz and 1 Hz on a heating process, equilibrating the temperature for 1 h between tests. FIGS. 34A-34C show AC impedance results for the temperature range of 23° C.-100° C. for a77.5 (FIG. 34A) and two of the three SEPMs (methyl-imine composite, FIG. 34B; hexa-imine composite, FIG. 34C). A steep tail at low frequencies indicates good contact was made between the AG-blocking electrodes and electrolyte layer.

Typical equivalent circuits for ion blocking electrodes fit to the data in conjuncture with Equation (5) to back out resistance and thus conductivity values. The activation energy was determined from the slope of the Arrhenius plot.

$$σ = \frac{l}{RA} \qquad Equation 5$$

A reinforced cell die was used for all cycling tests. A pyrite-based cathode was prepared by hand mixing FeS₂ (Washington Mills, SULFEX Red), a77.5, and C65 (Timcal) in a 5:5:1 weight ratio. A large enough batch was prepared to mount on both the standard and SEPM separators. 5 mg of cathode was pressed onto aluminum foil at 38 MPa. 10 mg of prepared a77.5: polyimine powder was then pressed onto the cathode at 76 MPa. The whole stack then underwent the same HT procedure as before. Finally, an indium-lithium alloy (In+Li×In, 0<×<1) was pressed onto the prepared cell at 76 MPa. Galvanostatic cycling of cells occur on an Arbin B2000 Battery Testing Station. A rate of C/10 refers to an aerial current density of 0.15 mA cm⁻². Volumetric energy densities are calculated by measuring the tap density of the prepared cathode powder pressed into discs at 228 MPa.

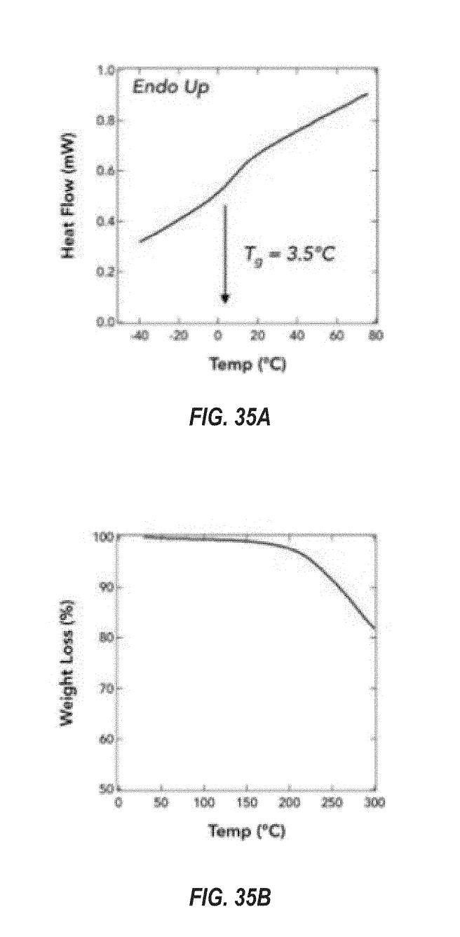

FIGS. 35A and 35B present differential scanning calorimetry (DSC) and thermogravimetric analysis (TGA) results of the methyl-imine formulation, confirming a glass transition temperature (T_{g}) at 3.5 ° C. and high-temperature stability. DSC measurements were carried out on a Mettler Toledo DSC823e at a 5 ° C. min⁻¹ scan rate. Methyl-imine has a glass transition temperature at 3.5 ° C. and loses about 1% of its mass by 162 ° C. This mass loss may be the limiting factor for using SEPM based solid-state batteries at elevated temperatures as the a77.5 solid electrolyte is stable up to the crystallization temperature. Samples were run on a TA Instruments Q-500 series thermal gravimetric analyzer with samples held in a platinum pan under nitrogen atmosphere. A 10 K min⁻¹ ramp rate was used. FIG. 35A is a DSC thermogram of methyl-imine and illustrates determination of T_{g} by the onset method. FIG. 35B is a TGA curve of methyl-imine.

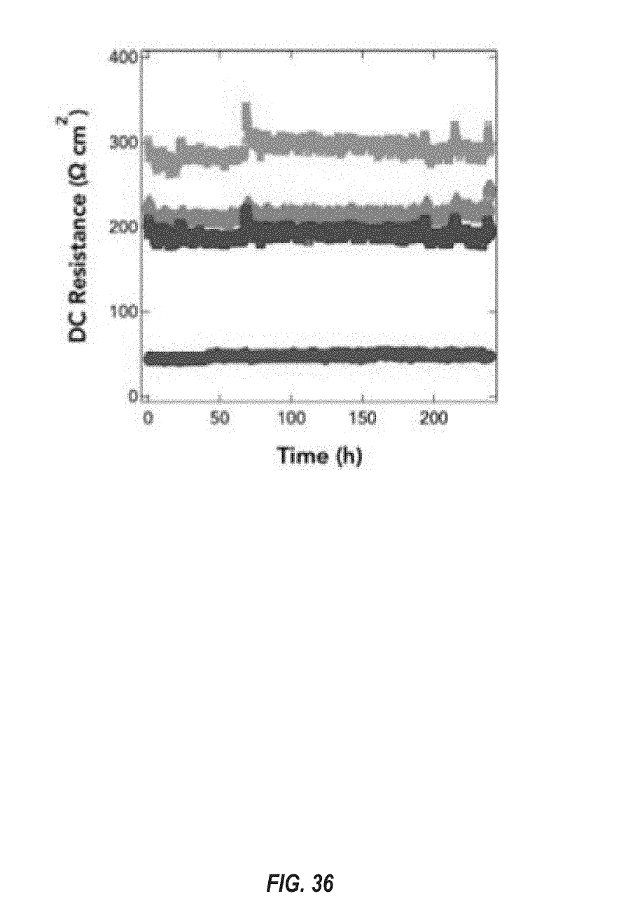

To measure long-term interaction between polyimine and electrolyte, i.e., decomposition of material, we can use a DC pulse technique to measure internal resistance of SEPMs. DC pulse resistance measurements are taken on symmetric lithium cells (lithium/SEPM/lithium) using a 0.1 mA pulse applied every 5 minutes. FIG. 36 displays long-term DC resistance of un-heat-treated composites in contact with lithium metal electrodes at 60° C. to exacerbate any possible interactions. This serves the dual purpose of also measuring long-term stability with lithium and polyimine As it can be seen, there are no general increases across any SEPM samples. a77.5 is already known to be stable in contact with lithium metal. The few fluxuations occurring across the 10 days in the polyimine samples occurred at the same time, and it was thus concluded that this was directly due to temperature changes in the oven (opening the oven door).

Further examination of the electrochemical characteristics of the polyimine material was conducted, for example to determine whether the polyimine was lithium active. Electrochemical stability was tested using linear sweep voltammetry (LSV) with a lithium/a77.5/polyimine/titanium construction at a scan rate of 1 mV s-1. LSVs were performed from OCV up to 5 V and down to 0.1 V corresponding to anodic and cathodic sweeps, respectively. FIG. 33A illustrates cathodic and anodic linear sweep voltammetry of pure a77.5 and methyl-imine Peaks in the anodic a77.5 sweep are attributed to excess Li₂S in the electryolyte. Methyl-imine appears to be electrochemically inert to lithium in the range of 0-5 V.

Anodic and cathodic sweeps yielded no response meaning no interaction between the two. This is expected as methyl-imine is neither electrically or ionically conductive, a necessity to have some reduction of lithium ions.

Second, in order to see if there are any mobile species within methyl-imine, we tested lithium ion transference number in both pure a77.5 and the methyl SEPM (FIG. 34B). Lithium ion transference number is calculated using the Bruce-Vincent-Evans (BVE) technique as in Equation S3. SEPMs are constructed into a symmetric lithium cells (lithium/SEPM/lithium); lithium is scraped prior to use to remove any native layer. BVE requires the measurement of initial and steady state current, I0 and IS, respectively, for a given DC polarization, ΔV. Initial and steady state resistance values, R0 and RS, are determined through AC Impedance using the same test as before. Steady state is determined once less than a 1% change in current occurred in a 10 minute period.

$${t}_{Li +} = \frac{{I}_{S} ( Δ V - {I}_{o} {R}_{O} )}{{I}_{O} ( Δ V - {I}_{S} {R}_{S} )} \qquad Equation 6$$

Solid superionic conductors are well known for having transference values of unity meaning the only mobile species are lithium ions hopping between vacancies. In the SEPM, we see the same value showing no negative interactions caused by the addition of polyimine FIG. 34C displays the initial and steady-state impedance sweeps used to calculate transference number.

The advantages of the above described polymers, batteries incorporating the above-described polymers and methods of manufacturing should be readily apparent to one skilled in the art. Additional design considerations may be incorporated without departing from the spirit and scope of the invention. It should thus be noted that the matter contained in the above description and/or shown in the accompanying drawings should be interpreted as illustrative and not in a limiting sense. Accordingly, the following claims are intended to cover all generic and specific features described herein, as well as all statements of the scope of the present methods, and systems which, as a matter of language, might be said to fall there between. It will be appreciated that other components may be added to the matrix, such as ionic salts.

What is claimed is:

1. A Li-ion electrolyte membrane for a battery, comprising
electrolyte, and
a polyimine polymer for forming a continuous network about the electrolyte and being capable of repeating at least one cycle of transitioning between a non-malleable state and a malleable state and between a malleable state and a non-malleable state upon exposure to a temperature range comprising:
a low temperature range that is below a transitional temperature wherein said polymer exhibits rates of covalent bond exchange reactions that impart a non-malleable state to said polymer; and
a high temperature range above said transitional temperature wherein said polymer exhibits rates of covalent bond exchange reactions that impart a malleable state to said polymer.
